(19) United States
(12) Patent Application Publication
(10) Pub. No.: US 2011/0059209 A1
(43) Pub. Date: Mar. 10, 2011

(54) AUTOMATED PIZZA PREPARATION AND VENDING SYSTEM

(75) Inventor: Puzant Khatchadourian, New York, NY (US)

(73) Assignee: K & G Enterprises, LLC, New York, NY (US)

(21) Appl. No.: 12/685,506

(22) Filed: Jan. 11, 2010

Related U.S. Application Data
(63) Continuation of application No. 12/472,844, filed on May 27, 2009, now abandoned.
Application No. 12/472,844 is a continuation of application No. 12/246,006, filed on Oct. 6, 2008, now abandoned.
Application No. 12/246,006 is a continuation of application No. 12/035,827, filed on Feb. 22, 2008, now abandoned.
(60) Provisional application No. 60/891,218, filed on Feb. 22, 2007.

(51) Int. Cl. B65B 25/06; A47J 43/00; A23P 1/00; A21B 1/48

(52) U.S. Cl. 426/232; 99/494; 99/537; 99/450.1; 99/443 C; 426/413

(57) ABSTRACT

An apparatus and method for preparing and cooking pizza using fresh ingredients, the apparatus being in the form of a vending type of machine. By way of a keypad, touchpad, display or other user interface provided on the machine, a user specifies the type of pizza that they want. The machine then proceeds to combine the ingredients needed to create the requested pizza, cooks the pizza, as appropriate, places it in a box, and dispenses the boxed pizza to the user or customer. The dough may be provided in the form of sealed canisters or tubes, which are opened in an automated fashion. Slices of dough may be cut from the dough canisters for each pizza which is to be made. Sauce may be provided in the form of sealed tubes, bags, or containers, whereby a controlled amount of the sauce may be dispensed by way of a controlled dispensing system, such as a pump or similar mechanism. Finally, the cheese may be provided in a bag or other container, whereby a measured amount of cheese may be dispensed and provided on each pizza as it is prepared. The pizza preparation machine may also include a refrigerated section for maintaining ingredients which need to be refrigerated at an appropriate temperature in order to maintain the freshness of such ingredients, as well as to maintain a proper sanitary and food handling environment. The pizza preparation machine may also include an oven section where the pizza is cooked. Additionally, the pizza preparation machine may also include a box formation section where a box may be formed for the pizza to be placed inside the box.

### CROSS REFERENCE TO RELATED APPLICATIONS

This application is a continuation of U.S. patent application Ser. No. 12/472,844, filed May 27, 2009, which is a continuation of U.S. patent application Ser. No. 12/246,006, filed Oct. 6, 2008, which is a continuation of U.S. patent application Ser. No. 12/035,827, filed Feb. 22, 2008, which claims priority to provisional application No. 60/891,218, filed Feb. 22, 2007. The contents of each of these applications is incorporated by reference herein in their entirety.

### FIELD OF THE INVENTION

The present invention generally relates to the field of food preparation and vending systems. More specifically, the present invention relates to an automated system for preparing and vending individual pizzas for consumption.

### BACKGROUND OF THE INVENTION

Pizza is a very popular food in many countries throughout the world. Although pizza is a relatively simple food, having generally just three ingredients in its most basic form—dough, tomato sauce and cheese, there are many variations in the taste and quality of the finished, cooked pizza. There are also a number of ways of preparing and cooking pizza. The most common and typical method of preparation and cooking is what is referred to as “fresh” pizza. This method generally involves the flattening of the dough, placement of the sauce and cheese on the dough, and subsequent cooking in an oven. Once removed from the oven, the “fresh” pizza is consumed while it is still hot or warm.

The popularity of pizza has led to many different methods of preparation and cooking in order to provide pizza to consumers in many different forms, such that it is available to be consumed in virtually any place. The typical method of preparation and cooking, as outlined above, is generally performed in a pizza parlor, or in an individual's home, where the ingredients, as well as an oven are available. The pizza is then consumed at the pizza parlor, or at the home, whichever is more convenient. However, this typical method of preparation and cooking requires one to have the necessary ingredients available, and to also have an oven available for use. These requirements restrict the availability of “fresh” pizza.

Several approaches have been developed to address these requirements of pizza preparation, i.e., the requirement for the necessary ingredients, and the requirement for the oven. One such approach involves the use of frozen pizzas. This approach eliminates the requirement for having the necessary ingredients on hand. Instead, the prepared, frozen pizza, which can be purchased at a store ahead of time and stored in one's freezer, can then be cooked in one's oven at any convenient and desirable time. However, the use of frozen pizzas still requires one to have access to an oven. Also, the resulting pizza is sometimes not of the same taste quality as “fresh” pizza, i.e., where the ingredients are assembled together and then cooked right away.

Another approach which has been developed in order to make pizza more readily available in more places, is the use of vending systems or vending machines. These machines typically use prestored, frozen pizza which are then cooked in an oven within the vending machine and then dispensed to a customer. This approach eliminates the need for having the necessary ingredients and for having an oven available. However, such vending machines typically use frozen pizza as the starting point. As a consequence, the resulting pizza produced by such a machine is not really considered “fresh” pizza, nor does its resemble that of “fresh” pizza.

Yet another approach to preparing pizza by way of vending machines is the use of fresh ingredients in order to better provide what is considered a “fresh” pizza. Such machines are disclosed in, for example, U.S. Pat. Nos. 5,921,170 and 6,086,934 both to Khatchadourian et al., the contents of which are hereby incorporated herein by reference.

### SUMMARY OF THE INVENTION

The present invention is directed to an apparatus for preparing and cooking pizza using fresh ingredients, the apparatus being in the form of a vending type of machine. By way of a keypad, touchpad, display or other user interface provided on the machine, a user specifies the type of pizza that they want. The machine then proceeds to combine the ingredients needed to create the requested pizza, cooks the pizza, as appropriate, places it in a box, and dispenses the boxed pizza to the user or customer.

Generally, the pizza preparation machine (also referred to as the pizza making apparatus or machine) is provided with fresh ingredients in various types of appropriate containers. For example, the dough may be provided in the form of sealed canisters or tubes, which are opened in an automated fashion. Slices of dough may be cut from the dough canisters for each pizza which is to be made. Sauce may be provided in the form of sealed tubes, bags, or containers, whereby a controlled amount of the sauce may be dispensed by way of a controlled dispensing system, such as a pump or similar mechanism. Finally, the cheese may be provided in a bag or other container, whereby a measured amount of cheese may be dispensed and provided on each pizza as it is prepared.

The pizza preparation machine may also include a refrigerated section for maintaining ingredients which need to be refrigerated at an appropriate temperature in order to maintain the freshness of such ingredients, as well as to maintain a proper sanitary and food handling environment.

The pizza preparation machine may also include an oven section where the pizza is cooked. Additionally, the pizza preparation machine may also include a box formation section where a box may be formed for the pizza to be placed inside the box. For example, the pizza preparation machine may be provided with a stack of box blanks, i.e., folded boxes, such that the box formation section retrieves an individual box blank and folds it as appropriate in order to create a three-dimensional box. The pizza which has been cooked by the oven can then be inserted inside the formed box. The formed box may then be closed, and then dispenses to the user or customer by way of an opening in the pizza preparation machine.

The pizza making apparatus may also include appropriate controlled movement mechanisms employing controlled motors or other drivers for moving various elements within the machine in order to create the pizza and then transfer the pizza through the various sections within the machine. For example, such mechanisms may include a controlled knife for cutting a specific piece of dough, horizontal and vertical transfer mechanisms for moving the cut dough to the various sections of the machine, as well as controlled movement mechanisms for dispensing the ingredients or toppings in a specified amount and in a specified location. Additionally, sensors may be positioned in specified locations within the machine to indicate the presence or absence of particular events in order to facilitate the pizza making process. For example, sensors may be used to indicate the movement of the dough to a sufficient position to thereby indicate a predetermined thickness of dough which is to be cut by the knife Such sensors and controlled movement mechanisms may be operated in conjunction with a programmed processor or other electronic controller device.

### DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a front perspective view of the pizza making apparatus according to one embodiment of the present invention;

FIG. 2 is a front view of the pizza making apparatus of FIG. 1;

FIG. 3 is a perspective view of the canister handling and dough portioning system of the pizza making apparatus;

FIG. 4 is a left perspective view of the canister handling and dough portioning system of the pizza making apparatus;

FIG. 5A is a front cross sectional view of the canister lid removal system, with the canister about to enter the lid removal clamp;

FIG. 5B is a front cross sectional view of the canister lid removal system, with the canister pushed through lid removal clamp;

FIG. 5C is a front cross sectional view of the canister lid removal system canister retracted back out of the clamp, with the lid removed;

FIG. 6A is a right perspective view of the canister lid removal system with the lid about to be removed;

FIG. 6B is a right perspective view of the canister lid removal system with the removed lid being kicked into the lid container;

FIG. 7 is a cross sectional view of the lid removal and dough portioning system, with the canister into the dough knife hub and a portion of dough being cut;

FIG. 8A is a front right perspective view of the canister handling and dough portioning system, as well as the dough pressing and par-baking system, with a newly cut piece of dough;

FIG. 8B is a front right perspective view of the canister handling and dough portioning system with the newly cut piece of dough being lowered out of the refrigerated area;

FIG. 8C is a perspective view of the dough pressing system with the newly cut piece of dough about to be transferred to the hot press platform;

FIG. 8D is a perspective view of the dough pressing system with the dough portion just having been transferred to the hot press platform;

FIG. 8E is a perspective view of the dough pressing system with the press platform under the top press plate;

FIG. 8F is a perspective view of the dough pressing system with the pushing arm in the refracted position;

FIGS. 9A to 9I are front cross sectional views of the hot press and par-baking system depicting various stages of the pressing process;

FIG. 10A is a front right perspective view of the dough pressing system and the pie topping area, showing the newly made pie crust being transferred to the topping area;

FIG. 10B is a front right perspective view of the pie topping area, showing the sauce spreading process;

FIG. 11A is a front left perspective view of the pie topping area showing the cheese dispensing mechanism;

FIG. 11B is a front right perspective view of the cheese dispensing mechanism with the cheese canister and the canister base removed to depict the bag insertion process;

FIG. 11C is a front exploded view of the cheese dispensing mechanism;

FIGS. 11D and E are front left perspective views of the pie topping area showing the cheese dispensing and spreading process;

FIGS. 12A to 12C are front right perspective views of the pie oven transfer system;

FIG. 13A is a rear sectional view of the conveyor oven;

FIG. 13B is a rear perspective view of the oven and the packaging system showing the pizza about to be transferred to a box;

FIG. 14A is a front view of the box forming system;

FIGS. 14B to 14D are front right perspective views of the box forming system, depicting the box separation and opening sequence;

FIGS. 15A to G are left side views of the rear flap folding mechanism, depicting various stages of the box flap closing process;

FIG. 16 is a block diagram of a first embodiment of an electronic control system for the present invention;

FIG. 17 is a block diagram of an alternative embodiment of an electronic control system for the present invention; and

FIG. 18 is a flowchart of the process performed by the present invention to prepare a pizza.

### DETAILED DESCRIPTION OF THE INVENTION

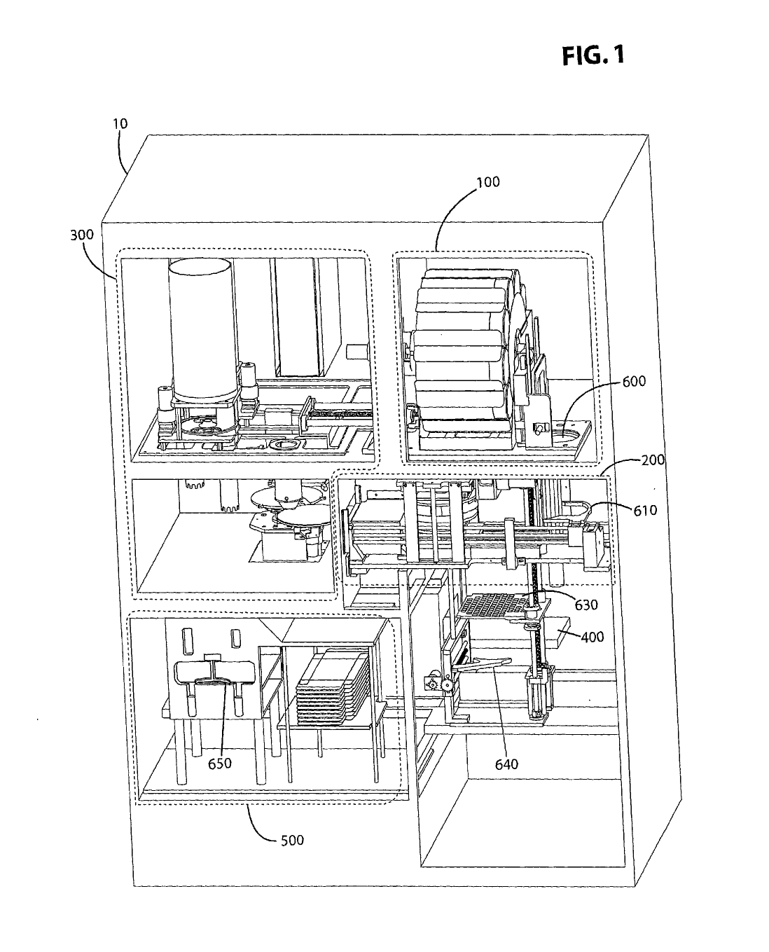

Referring now to FIG. 1, an apparatus 10 for making pizza is illustrated. The apparatus includes a dough-storage and handling area 100, a dough pressing and par-baking area 200, a topping storage and dispensing area 300, an oven 450, and a packaging area 500. The apparatus also includes mechanisms that serve to transfer the pizza between these areas. These transfer mechanisms include the dough slice elevator 600, the plate transfer arm 610, the elevator transfer arm 620, the pizza elevator 630, the oven transfer arm 640, and the box transfer arm 650 (not visible in FIG. 1).

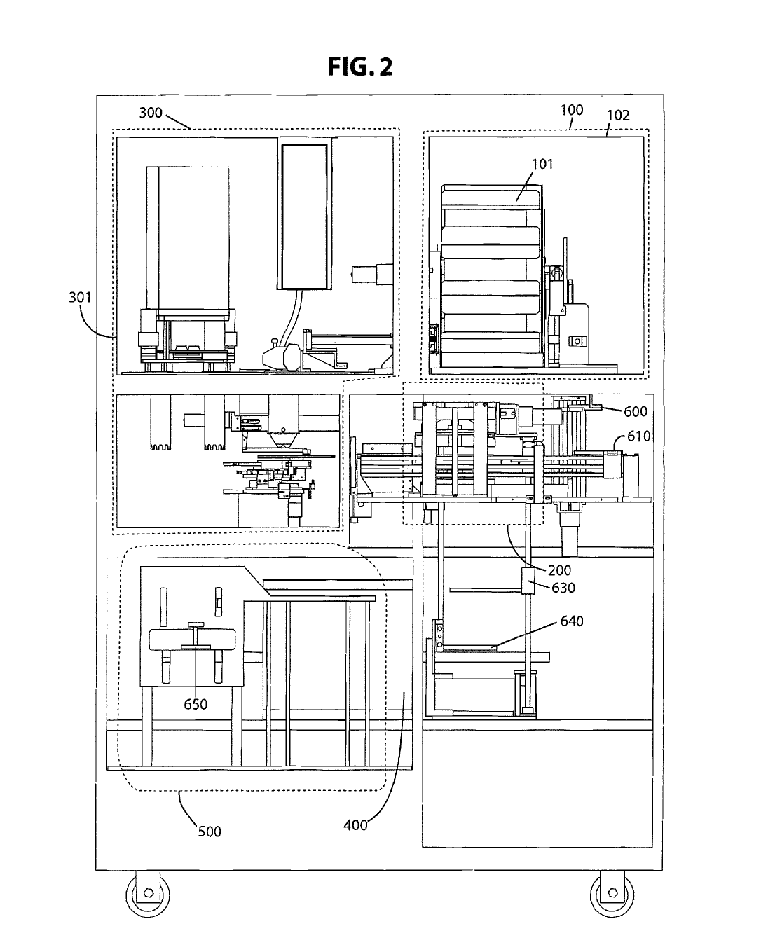

Referring now to FIG. 2, the dough storage and handling system 101 is enclosed in a refrigerated compartment 102, which is kept at a temperature which is preferably between 18° and 24° F., and the topping storage and dispensing area 300 is enclosed in a refrigerated compartment 301, which is kept at a temperature which is preferably between 34° and 40° F.

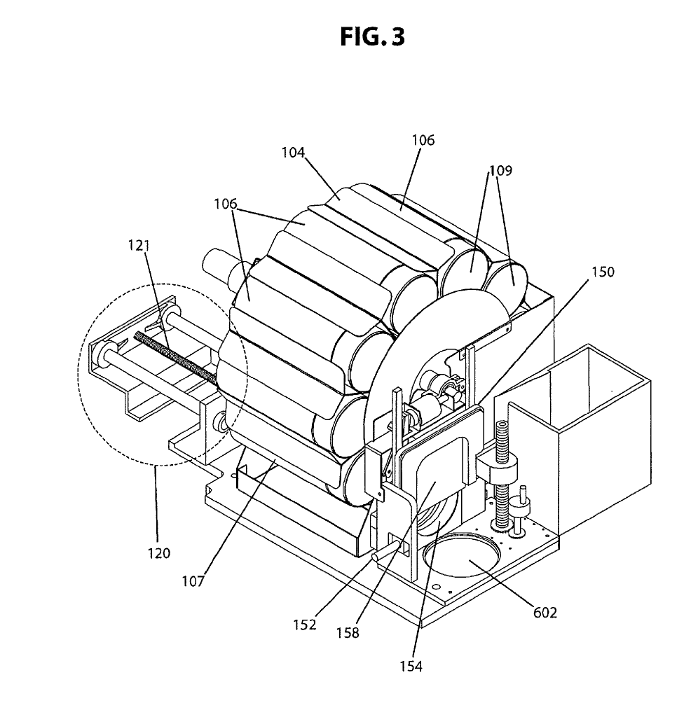

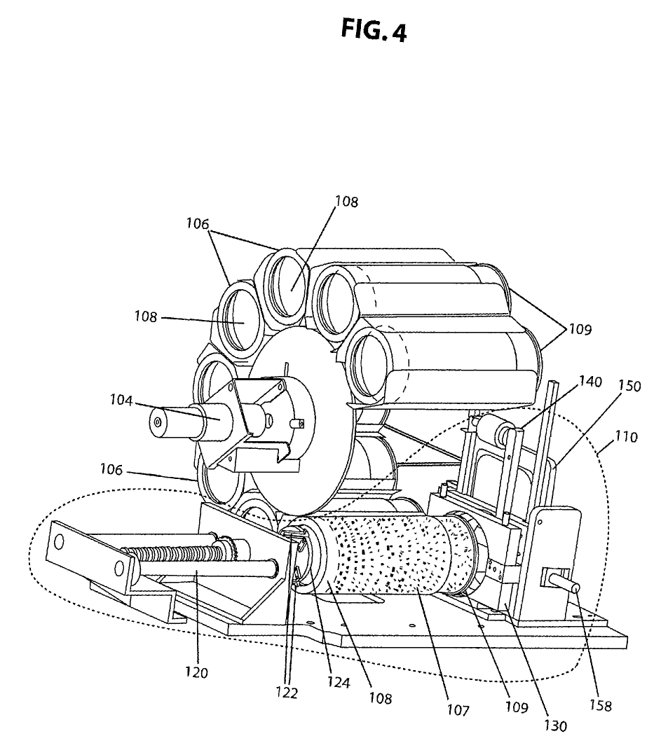

Referring now to FIGS. 3-4, the dough storage area includes a canister Ferris wheel 104 that houses a plurality of canisters 106. Each canister 106 is filled with dough and is sealed at its rear with a moving piston 108 and at its front with a lid 109. Each canister preferably has an internal diameter of four inches and is approximately ten inches in axial length. Alternatively, the internal diameter may be as much as five inches or more and the axial length may vary from eight to twelve inches. Of course, other configurations may be used depending on the particular application.

The canisters 106 are stored within Ferris wheel-like mechanism 104, which rotates to present each canister to the dough cutting station 110. The canister received in the dough cutting station will be referred to as canister 107. The dough cutting station assembly 110 includes an extruder mechanism 120, a lid removal clamp 130, a lid kicker mechanism 140 and a dough-cutting mechanism 150. When the canister Ferris wheel mechanism 104 introduces the canister 107 to the cutting station, the canister is centered axially with extruder 120, lid remover 130 and dough cutter 150 mechanisms.

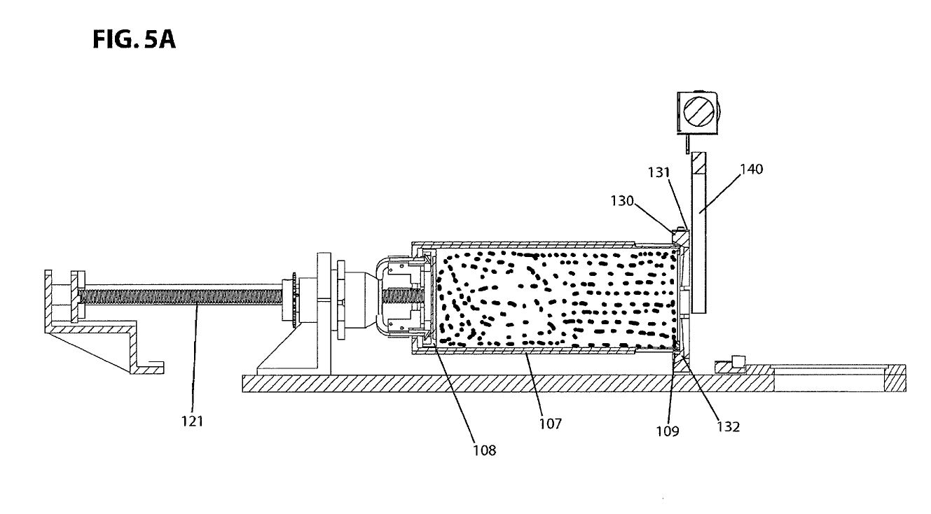

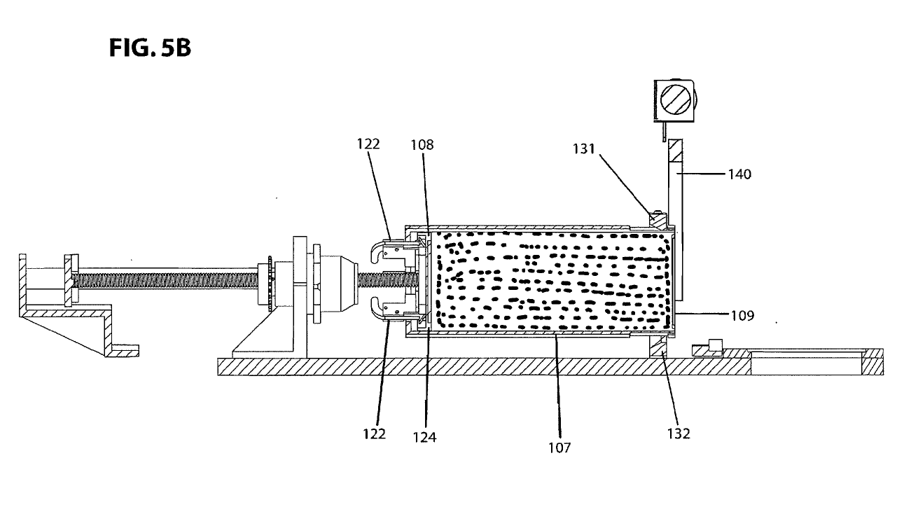

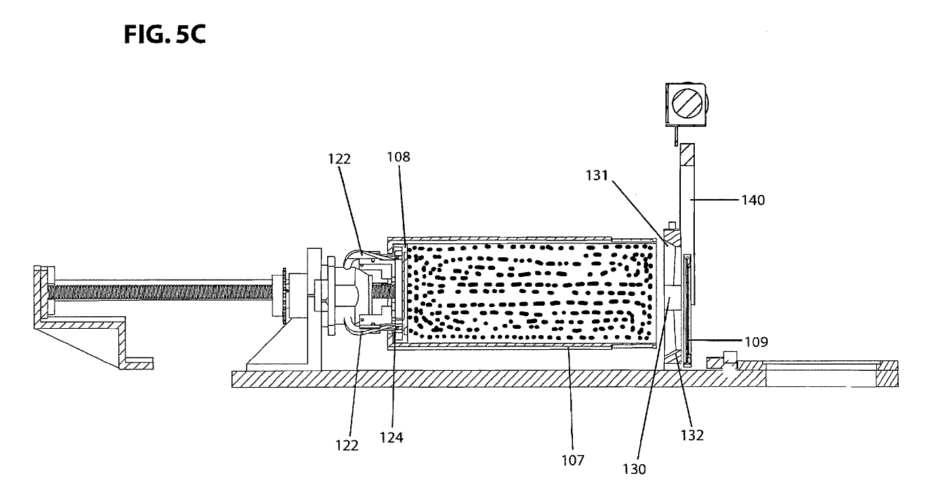

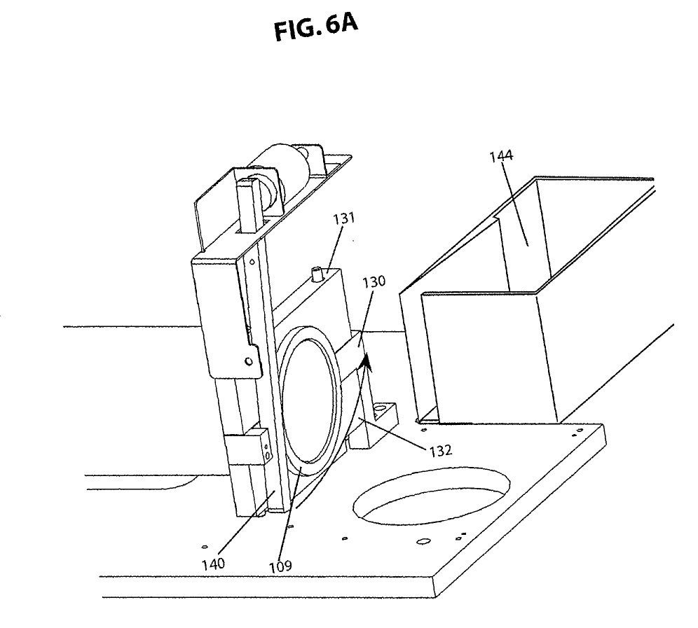

Referring now to FIGS. 5A-5C, the canister lid removal process will now be described. First, the extruder mechanism pushing shaft 121 advances, bringing the extruder pusher plate 124 into contact with the internal piston 108 of the canister 107 to eventually push the front face of the latter beyond the lid removal clamp 130. The canister lid removal clamp includes two spring loaded semicircular blocks, 131 and 132, arranged vertically one on top of the other, such that when the canister is pushed against them from the left, they are deflected up and down, respectively, to allow the canister to pass through. In an alternative embodiment, one of the blocks may be fixed, with the other block being spring loaded so that it can deflect up and down with respect to the fixed block. Referring to FIG. 5B, when the lid 109 clears these blocks, they retract back onto the canister body. Upon the initial contact of the extruder pusher plate 124 with the internal piston 108 of the canister, a set of three spring loaded hooks 122 arranged along the perimeter of the extruder pusher plate 124 are deployed and act to engage the back end of the canister to permit the extruder to pull the canister back out of the lid removal clamp.

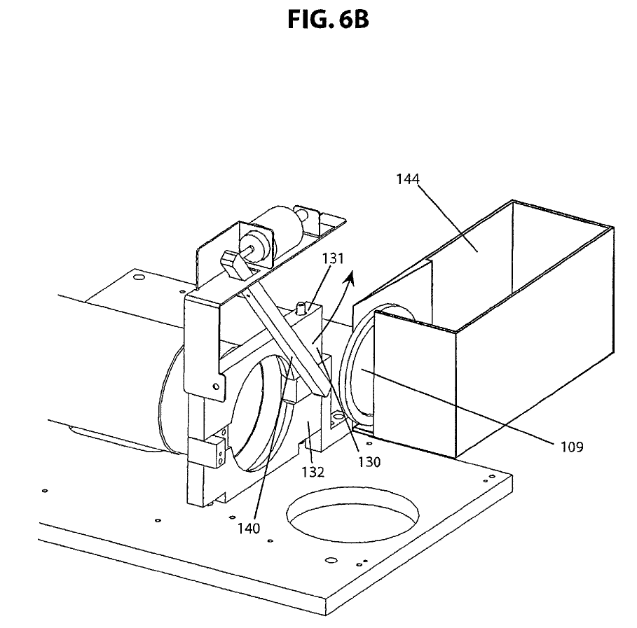

As the canister retracts back out of the lid removal clamp 130, the lid 109 is pushed off the canister as it is prevented from retracting by the lid removal clamp. Referring now to FIG. 6A, the lid 109 is moved out from in front of the canister by a kicker mechanism 140 that knocks the lid into a receptacle 144 in the rear of the canister area. In an alternative embodiment, the lid receptacle may have an upward slope at its entrance, such that once the lids are pushed in they can no longer come back out. Optionally, a photosensor may be used to detect whether or not the lid has properly been moved out.

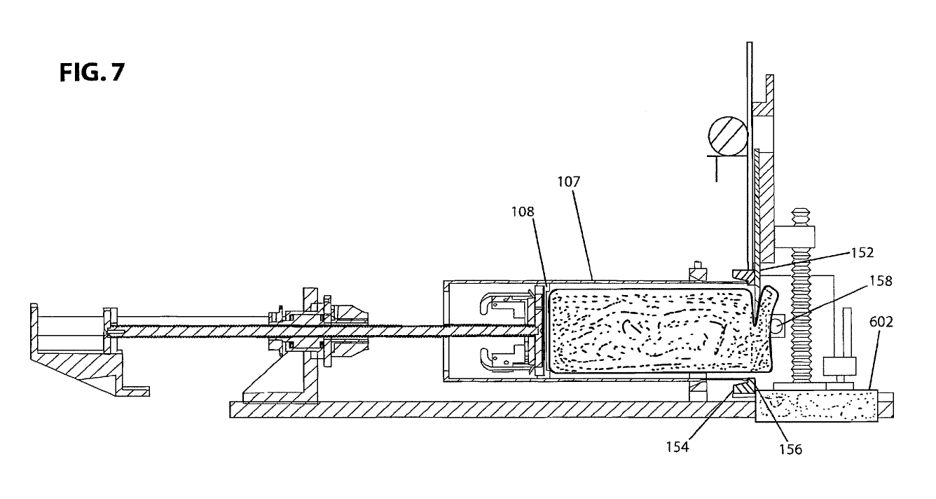

Referring now to FIG. 7, after the canister is opened, the extruder now pushes the canister into the dough cutting hub 154 and against a lip 156 at the edge of the dough cutting hub. The canister is now ready to extrude dough slices when an order is placed. Upon the reception of an order for a pizza, the dough cutting blade 152 is raised. This opens the way for the extruder to push dough out of the canister and through the cutting hub 154. In this case, the canister itself is prevented from advancing by the lip 156, such that the pressure generated on the piston 108 eventually disconnects the dough from the canister wall and pushes it through the dough cutting hub 154. As the dough advances, it is eventually detected by an electronic photosensor 158, which stops the extruder from pushing once the dough has been pushed a predetermined amount, i.e., when a predetermined thickness of dough has been pushed out of the dough canister. The position of the photosensor essentially determines the thickness of the dough slice. The dough cutting blade 152 now descends and cuts the dough to thereby create a dough slice. The newly cut slice falls onto an elevator surface 602, which lowers the slice out through the refrigerated area down to the level of the press mechanism.

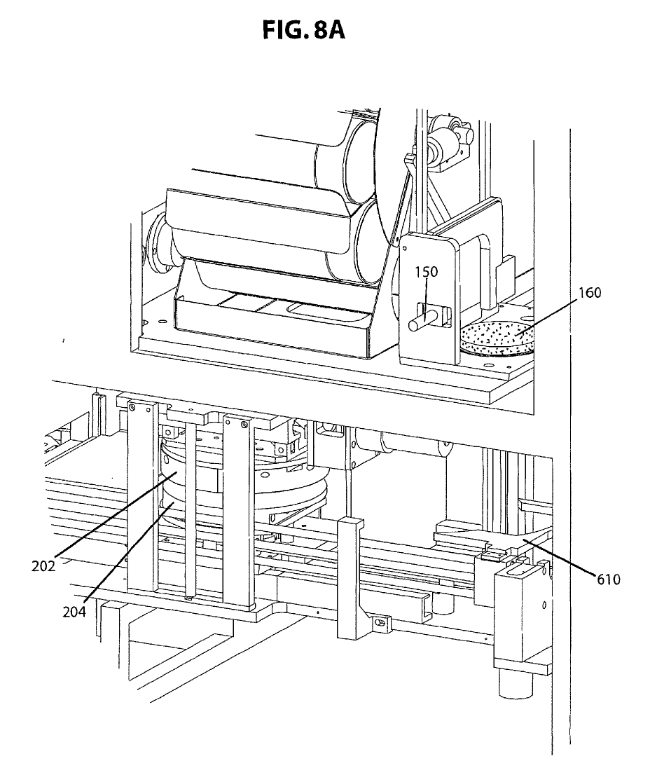

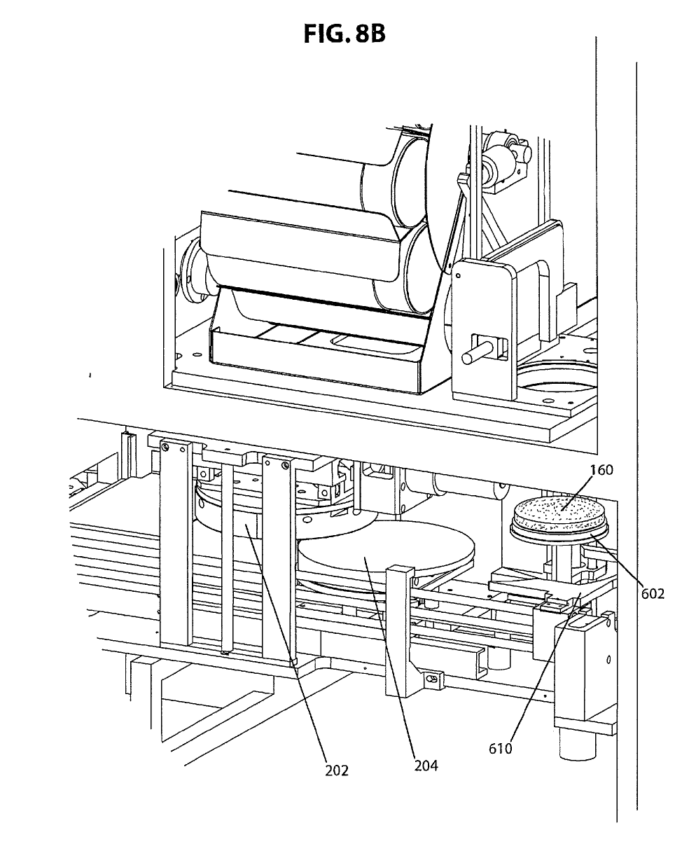

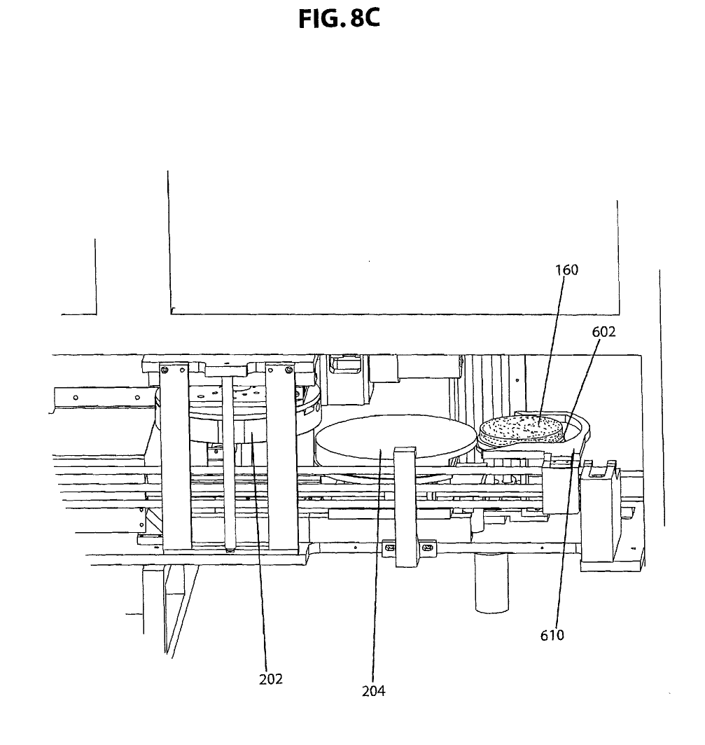

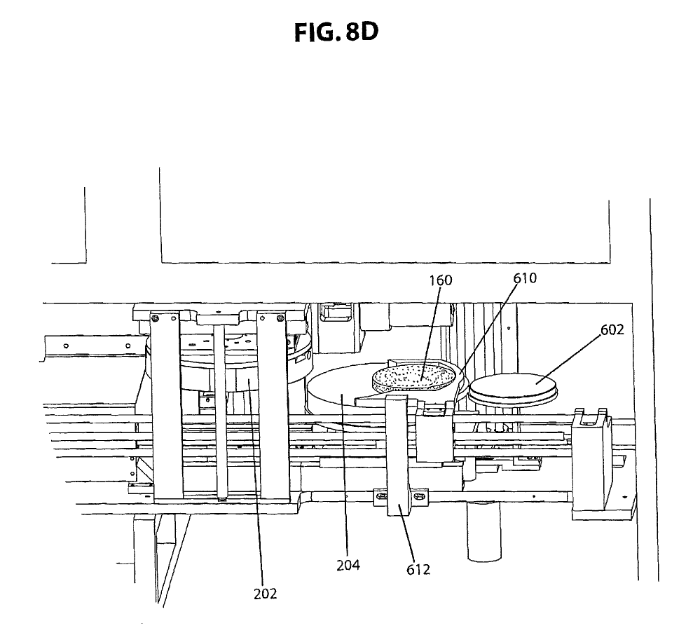

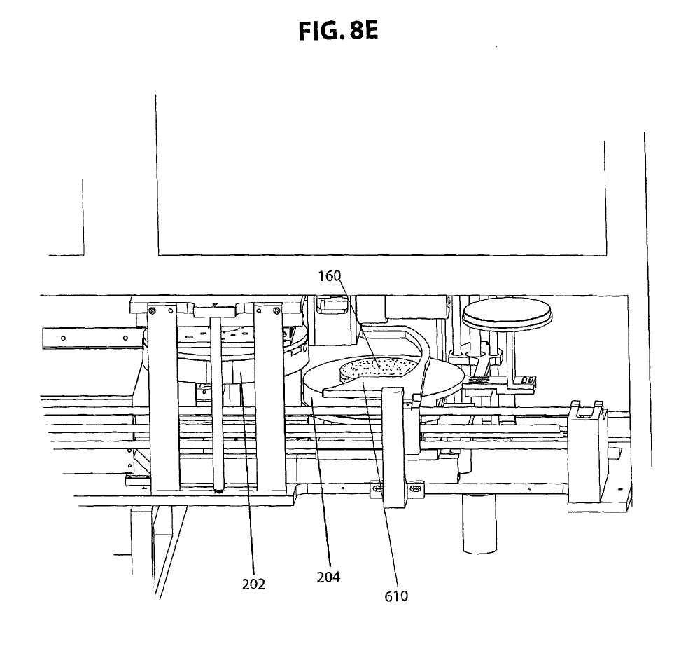

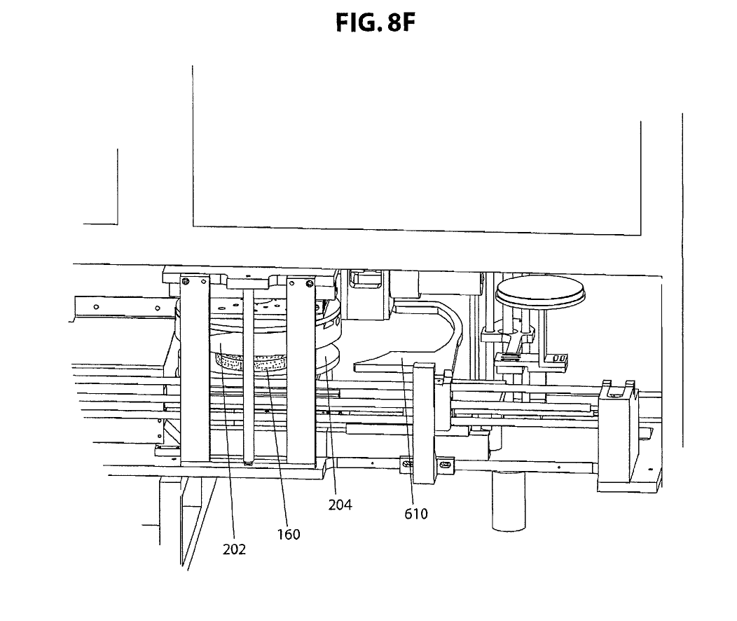

Referring now to FIGS. 8A-F, the dough puck or dough slice transfer to the press mechanism will be discussed. The press area includes a circular heated press top plate 202 that moves vertically from an uppermost position to a lowermost position, a circular heated lower press plate 204 that moves along the horizontal axis from a leftmost position to a rightmost position, and a pushing arm 610 that moves along the horizontal axis. The newly cut slice or piece of dough will be referred to as the dough puck 160. Upon reception of an order for a pizza, the press top plate 202 will move to its uppermost position, the press lower plate 204 will move to its rightmost position, where it will be adjacent to the dough slice elevator surface 602 when the latter is lowered with the freshly cut piece of dough. In an alternative embodiment, the lower press plate 204 may be fixed, and the top press 202 plate may then move with respect to the lower press plate 204. The plate transfer arm 610 now moves the slice of dough onto the lower press plate 204. Referring now to FIG. 8D, as the slice approaches the center of the bottom press plate, the arm 610 is deflected up when it contacts the plate transfer arm deflector 612. The sudden upward movement caused by this deflection severs the contact between the pusher arm 610 and the slice of dough. This insures that the dough slice remains centered as the lower press plate moves back to position itself under the top press plate 202. The dough puck 160 is now in position to be pressed.

In order to achieve fast and consistent results in producing pie crusts that are rigid enough to be pushed around to the various stations in the machine while maintaining a certain amount of lightness and airiness expected of pie crusts, the pressure buildup between the two plates must be controlled in order to prevent blowouts, deformities of the pie crusts, or crusts with bad texture. Excessive pressure can be caused by many factors such as variances of dough portion sizes, dough temperature, press temperature, differences of temperature between top and bottom plates, and even variances in the positioning of the dough. There must however be a certain amount of tolerance to allow for normal fluctuations for each of these factors. The goal is to press out the dough into pie crusts of consistent thickness. This is achieved through the press design and a particular pressing sequence, as described herein.

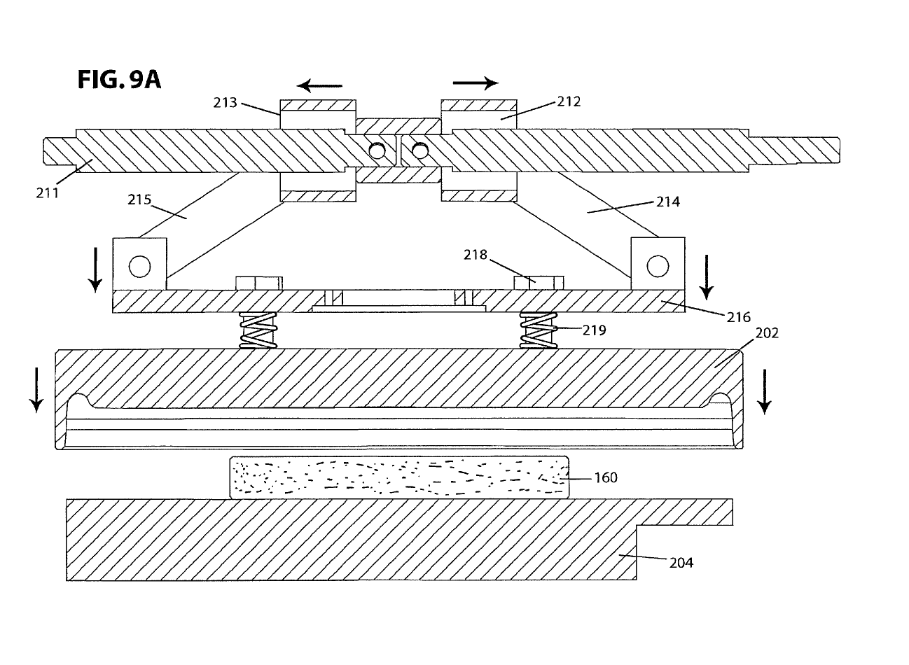

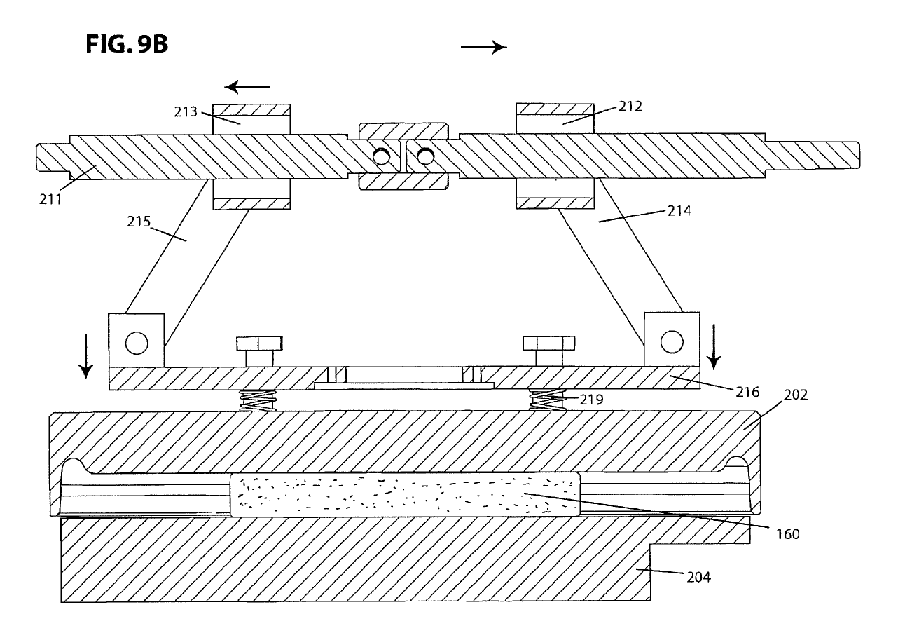

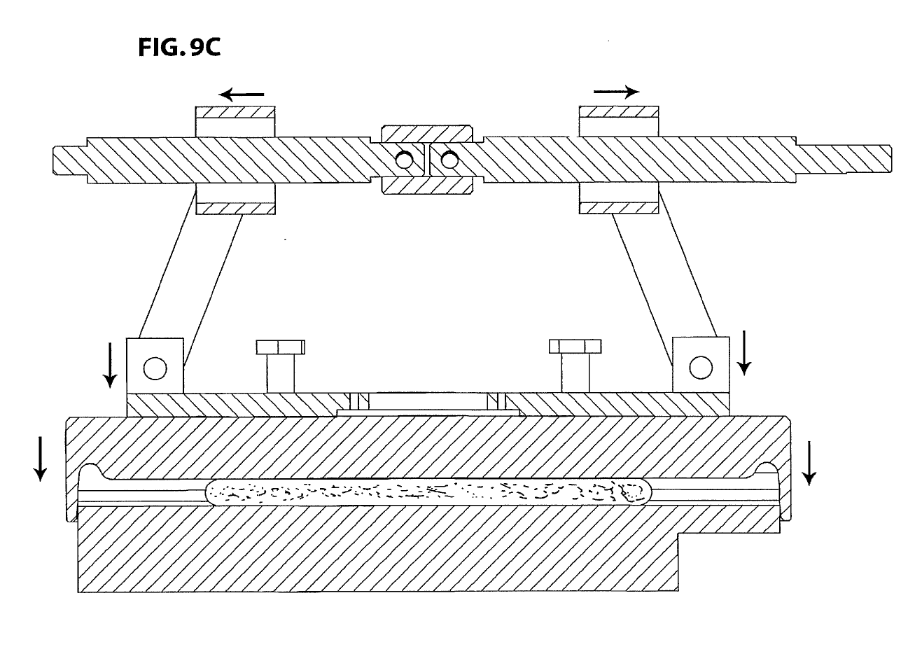

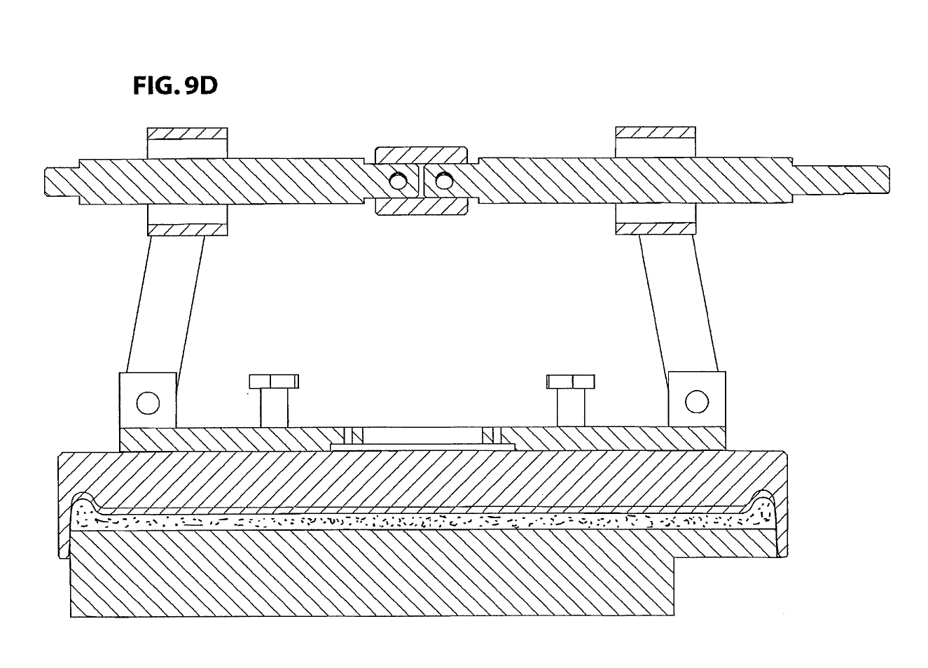

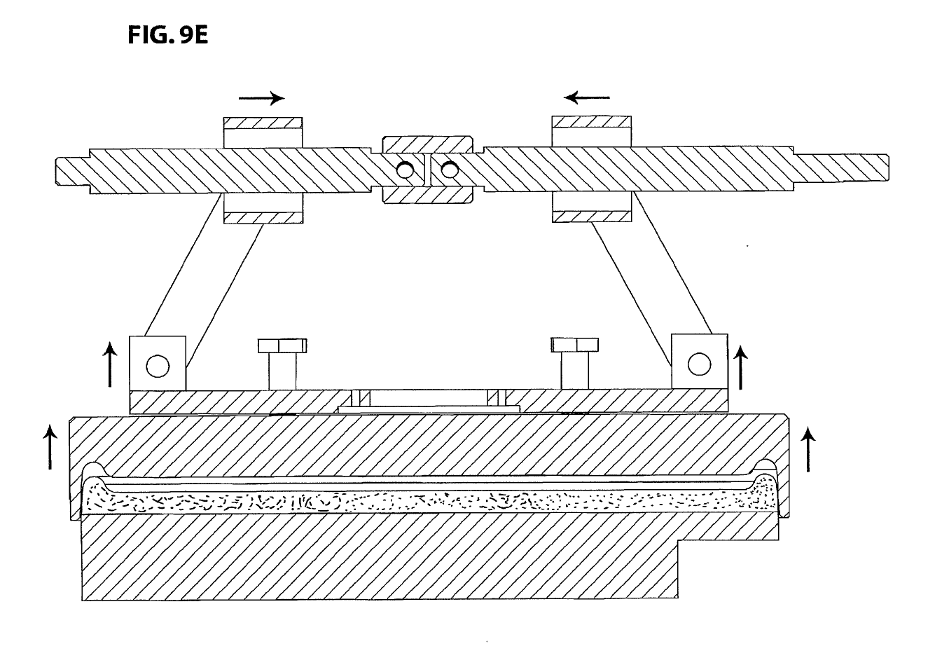

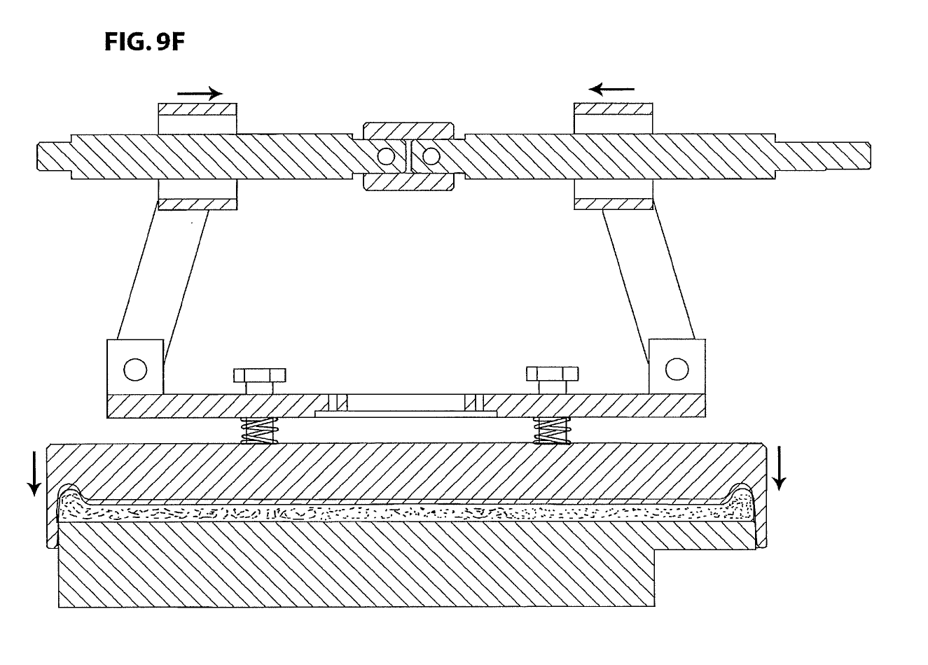

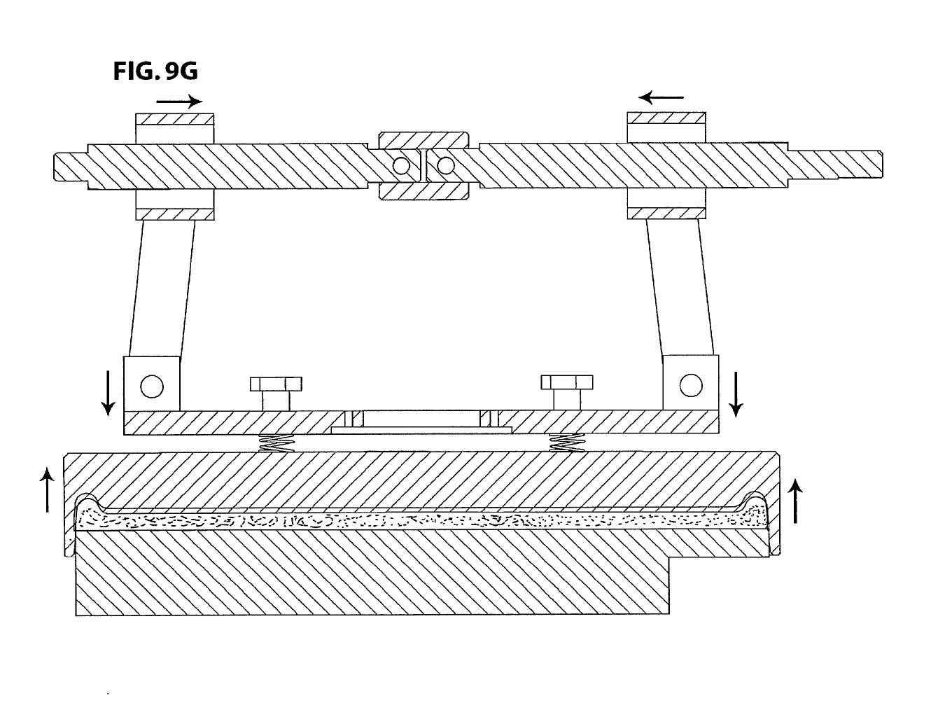

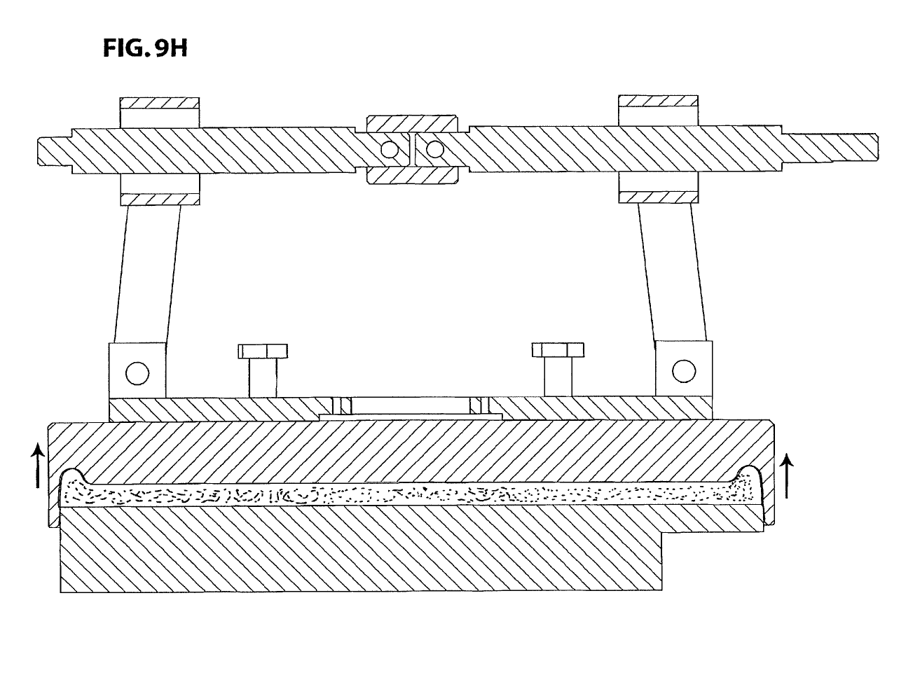

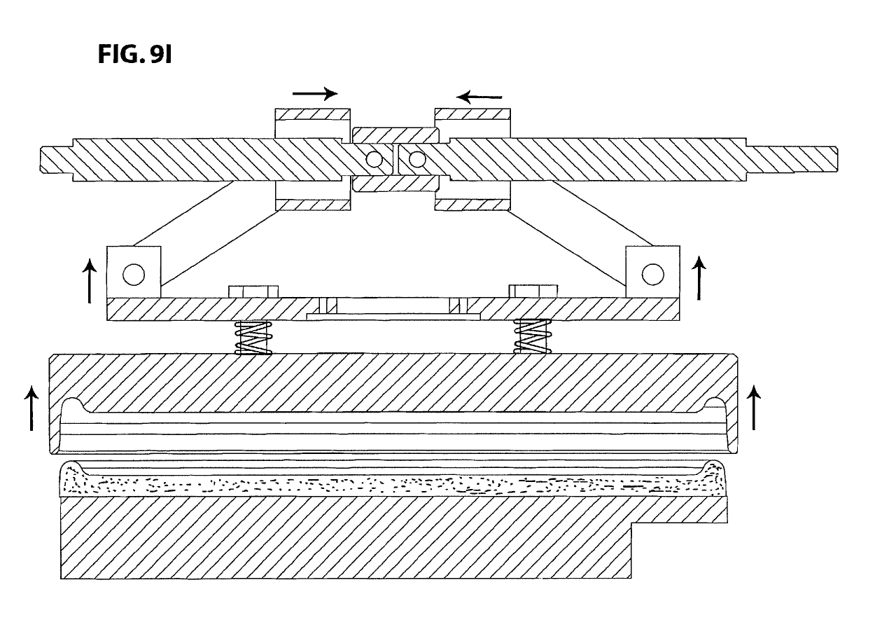

Referring now to FIG. 9A, the press mechanism includes heated top and bottom plates, 202 and 204, respectively. The top plate is actuated vertically due to the rotation of a lead screw mechanism that has two halves, 210 and 211, each having opposite directional threads. The rotation of the lead screw makes corresponding brackets 212 and 213 to move in opposite directions. These brackets, in turn, are each connected to a pair of levers that are in turn connected to a push plate 216. The top press plate 202 hangs on this push plate through shoulder screws 218, with light springs 219 around the shoulder screws between the two plates, to help assure that the press plate 202 does not get wedged at a non-horizontal angle, due to the screws.

The top press plate therefore descends to squeeze out and shape the dough slice 160 into, for example, an 8″ pie crust. When the top plate 202 reaches its lowermost position, it forms a cavity, which is then filled up by the dough slice 160. The dough slice therefore takes the shape of this cavity. The top and bottom press mechanisms are heated to par-bake the slice of dough to the point where the dough is rigid enough to be pushed around from station to station.

Referring now to FIGS. 9A-I, therein is illustrated the operation of the press mechanism. The following table lists the steps of the pressing sequence shown in each figure, from FIG. 9A to FIG. 9I.

| | Pusher Plate | |
|---|---|---|
| FIG | Movement | Description |
| 9A | Down | Press plate hanging from pushing plate. |
| 9B | Down | Press top plate sitting on top of pie, with a gap |
| | | between press plate & pushing plate. |
| 9C | Down | Pie being squeezed, no gap between plates. |
| 9D | End of travel | Both plates in lowermost position. Short pause in |
| | | this position. |
| 9E | Up | Press plate being pushed up against pushing plate |
| | | due to pressure buildup. |
| 9F | Midpoint A | Pushing plate moves up and stops at Midpoint A. |
| | | Somewhere between lowermost point & Midpoint |
| | | A, press plate drops back on top of pie due to |
| | | release of pressure. |
| 9G | Down | Pushing plate goes back down. Press plate sitting on |
| | | top of pie. |
| 9H | Midpoint B | Pusher plate stationary at Midpoint B, while press |
| | | plate is raised up by rising dough. Midpoint B is the |
| | | uppermost allowable rise position for the press plate. |
| 9I | Up | |

Referring now to FIGS. 9A-B, as the pushing plate is lowered, the top press plate first comes into contact with the slice of dough 160 and briefly stays there as the pushing plate continues its downward movement. Referring now to FIG. 9C, eventually the pushing plate comes back into contact with the top press plate and begins applying pressure on the dough slice through the top press plate. The slice is squeezed with consecutive slow bursts of downward movement, to allow the dough sufficient time to soften under the heat and expand without tearing or creating air pockets.

Referring now to FIG. 9D, as the top press plate reaches its lowermost position, the dough fills out the cavity between the plates and takes on the flat circular shape with slightly raised edges. In this position, with the dough slice in full contact with the press, the par-baking process begins, but as the cavity is fully sealed, there is a great increase in pressure between the plates.

Referring now to FIG. 9E, in order to limit the rise in pressure, after a short delay, the pushing plate begins to move back up in timed small spurts. Initially due to the pressure, the top press plate is pushed up against the pusher plate. Referring now to FIG. 9F, as the plates continue to rise the seal between the plates is eventually broken and some of the pressure is evacuated, causing the top press plate to fall back onto the pie, continuing the par-baking process. The exact point when the top press plate falls back onto the pie can be at any of a range of different positions. The pushing plate needs only to retract up to a pre-determined upper limit (midpoint A) where the seal between the plates is certain to have been broken and the pressure relieved. Accordingly, the shoulder screws 218 must be of sufficient length to allow the press plate to fall back onto the pie when the pressure drops.

Referring now to FIGS. 9G-H, with the press plate on the pie, the par baking process continues and similar to any dough baking process causes the pie to rise. The press plate therefore rises with the pie. However, the pusher plate comes back down to a second position (midpoint B) and remains at that point for the duration of the par-baking process, for example, approximately 20-30 seconds. This position sets an upper limit to the rise of the press plate and the dough under it, allowing the system to produce pies of approximately equal thickness. As the dough continues to dry out in this position, its maximal thickness gets set.

In an alternate embodiment, the pressing and par baking may be performed at two different stations rather than in one location with a single mechanism. The pie may first be pressed out under the press mechanism and may subsequently be par baked in a heated chamber located between the press mechanism and the pie topping plate. This method would have the advantage of reducing the lag time between pies, because a new pie can begin to be cut and pressed out as soon as the initial pressing of the previous pie is completed, instead of waiting for the additional par-baking time.

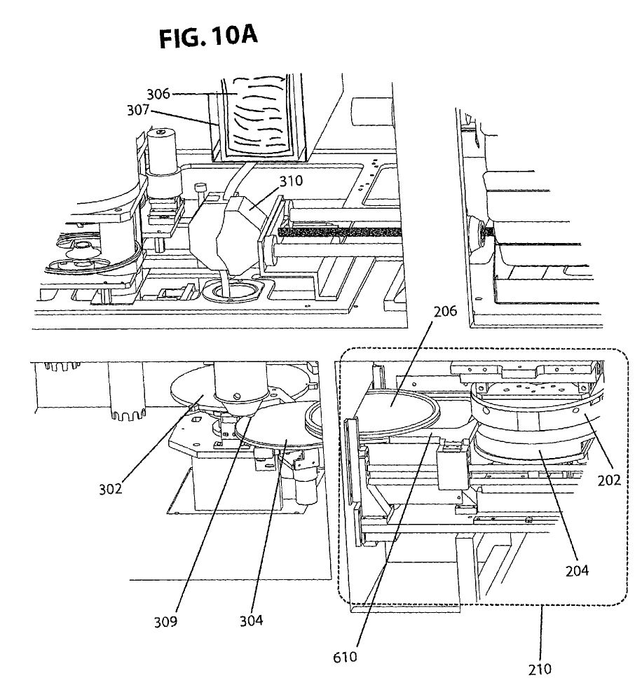

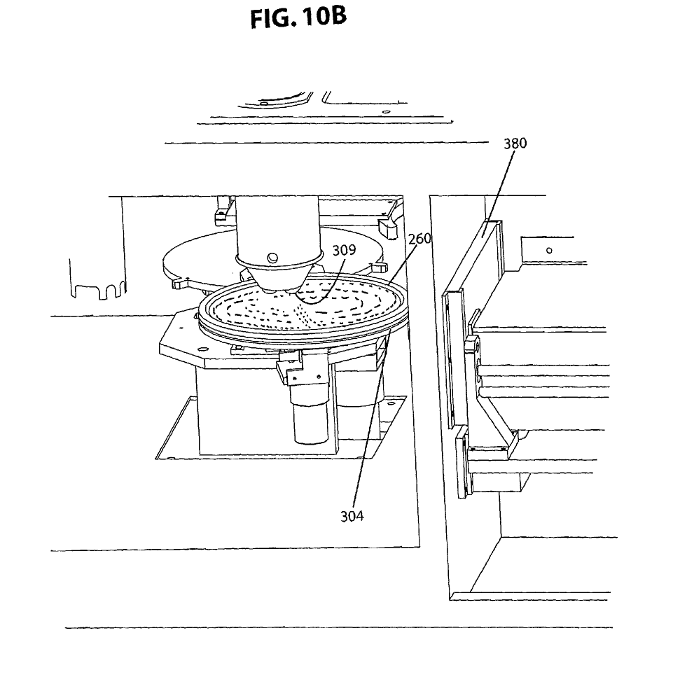

Referring now to FIGS. 10A-B, as the pressing and par-baking cycle approaches completion, the topping area entry door 400 opens, the turntable mechanism 302 rotates to position the topping plate 304 in line with the press bottom plate 204. Simultaneously, the press top plate 202 rises, and the plate transfer arm 610 then pushes the par-baked pizza crust onto the pie topping plate 304. The plate transfer arm 610 then retracts to its original position. The dough pressing area 200 is now ready to prepare the next pizza.

Referring now to FIG. 10B, the turntable 302 rotates to position the perimeter of the pizza crust 260 under the sauce tube end 309. The crust is then rotated by the pizza topping plate 304. Simultaneously to this, the sauce pump 310 draws sauce from the sauce bag 306 contained in the sauce container or box 307 through the sauce tube 308, and dispenses it onto the dough crust 260. The spinning of the plate causes the sauce to spread around the perimeter of the pie crust. When the perimeter of the pizza crust is covered with sauce the sauce pump stops pumping momentarily. During this pause, the turntable 302 rotates to now position the sauce tube end 309 further towards the center of the pizza crust. The sauce pump 310 then restarts the flow of sauce to cover the inner portion of the pie with sauce. This process is repeated once more by positioning the sauce tube end near the center of the pie crust and dispensing a small amount of sauce in the middle of the pie crust. Of course, a greater or lesser number of sauce dispensing cycles may be used, depending on the particular application. Optionally, a photosensor may be used to detect the presence of a pizza crust, and disable the sauce dispensing mechanism if a pizza crust is not detected, so as to prevent the dispensing of sauce in the event of a malfunction or improper operation.

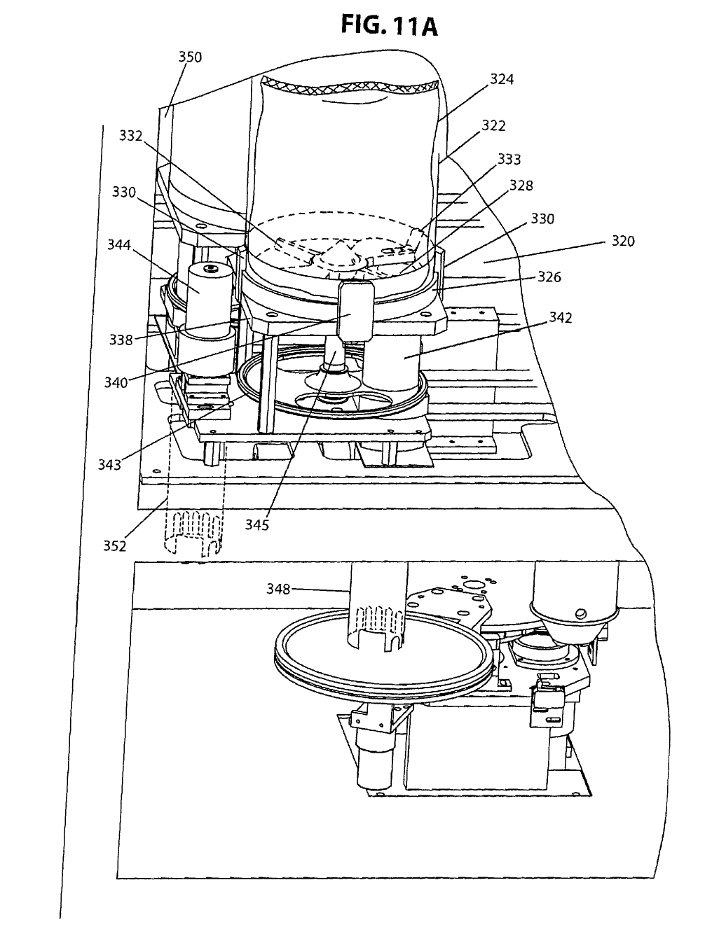

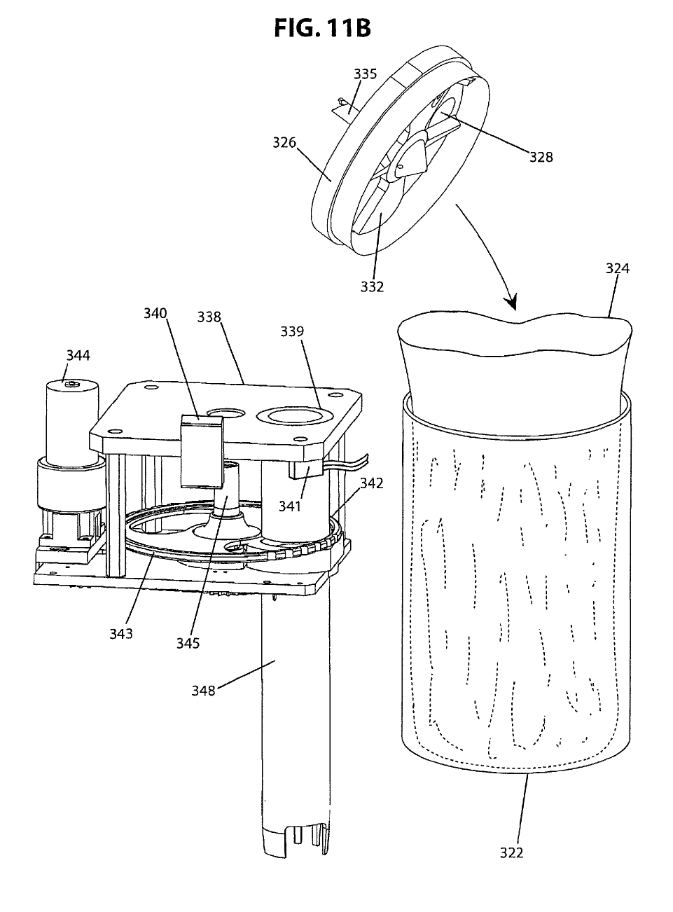

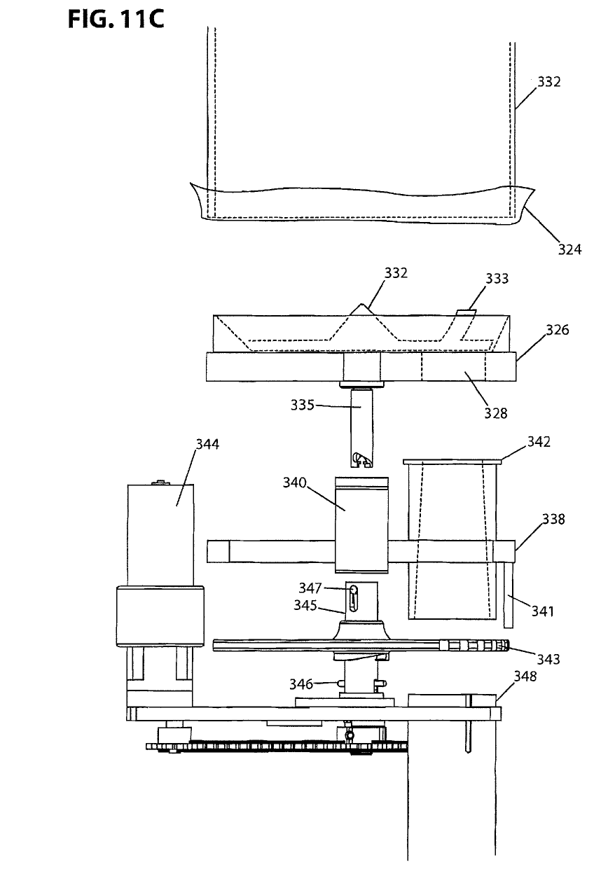

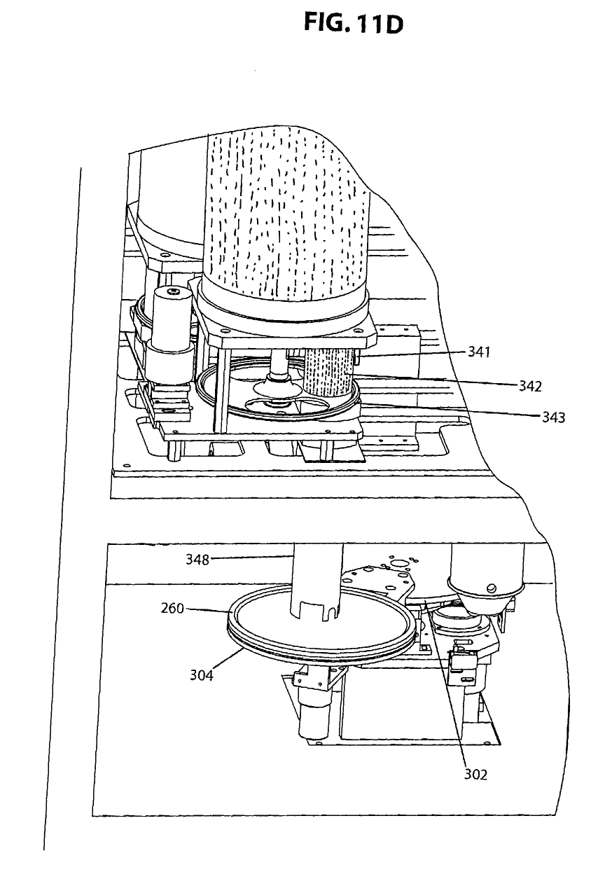

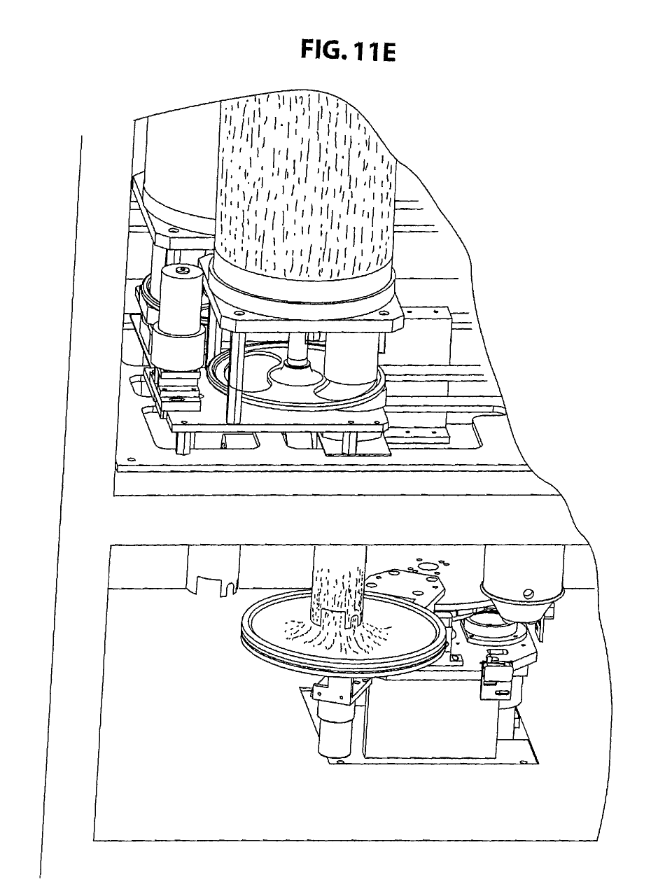

Referring now to FIG. 11A, therein is illustrated two cheese dispensing mechanisms, 320 and 350 respectively. Once the pizza is covered with sauce, the turntable 302 rotates to position the pizza crust 260 under the first cheese chute 348 or the second cheese chute 352, depending upon which cheese mechanism 320 or 350 is in use. The present description refers to the operation of the first cheese mechanism 320. The second cheese mechanism is substantially similar to the first mechanism.

Referring now to FIG. 11B, the cheese dispensing mechanism includes a cylindrical silo 322, for example, 8 inches in diameter, that contains a bag 324 of granulated cheese. The granulated cheese is commercially available and includes cubes of ⅛^{th} of an inch that may be provided in sealed bags. The cylinder diameter may be increased to increase the amount of cheese within each canister, but in such a case the bag must also be enlarged. The silo has a removable base 326. The base includes a circular disk made out of food grade plastic. The base has a dispensing hole 328, for example, approximately one inch in diameter, that permits the cheese to flow out. The base also has an agitating arm 332 that is shaped such that it can close the cheese dispensing hole 328 when made to stop at a particular position. The agitating arm is also shaped to have an extending scraper 333 that serves to wipe the bottom edge of the canister and promote a proper flow of cheese towards the dispensing hole.

The cheese bag 324 is inserted into the silo by removing the silo from the mechanism, turning it upside down and removing the base 326. At this point the cheese bag 324 may be inserted into the silo, with one end sticking out. The top of the bag is then cut or ripped open and folded over the edge of the silo, similar to a trash bag over a trash can. The base 326 may then be fitted into the silo, thereby wedging the bag in place. The base 326 may then be locked in position on the silo with a pair of latches 330. The silo may then be flipped back to a right side up position without fear of spillage due to the agitating arm 332 closing the exit hole 328 in the base 326. The cheese silo, with the newly installed cheese bag in it is now installed onto a support platform 338 on top of the cheese dispensing system. A coupling shaft 335 of the agitating arm, extending out from the bottom of the cheese silo base, is inserted through a hole on the silo support platform 338 and into a mating hole in the center drive shaft 345. The cheese silo is then locked into position with a pair of latches 340 that are positioned to insure that the cheese exit hole 328 of the silo base lines up with a corresponding hole 339 on the support platform. Just below these exit holes is measuring cylinder 342 that is inserted into the canister support platform hole 339 and is removable without tools in order to be cleaned. The measuring cylinder 342 is closed at the bottom by a circular rotating trap door 343. The latter has cutout holes that, when rotated to the correct position, allow the cheese to flow out. The rotating door is connected to the drive shaft 345, but it can be easily removed without tools in order to be cleaned by first removing the cheese silo and the measuring cylinder 342.

Referring now to FIG. 11C, a single DC motor 344, whose direction may be reversed and the speed controlled, is used to drive both the agitating arm and the measuring cylinder trap door. The motor is coupled to the drive shaft 345. In this case it is through a set of sprockets and a chain, but it may also be mounted directly to the drive shaft by being placed under the entire mechanism. The drive shaft 345 has a pair of internal spring-loaded drive pins, one pin 346 near the bottom which couples to the measuring cylinder trap door 343 and the other pin 347 further above which couples to the bottom of the agitating arm coupling shaft 335. When the drive shaft 345 rotates one way the agitating arm coupling shaft 335 is engaged to actuate the cheese actuating arm, and when the drive shaft 345 rotates in the opposite direction, the buffer door 343 is engaged.

Referring now to FIG. 11D, therein is illustrated the cheese dispensing process. The first step in the cheese dispensing process is to fill the measuring cylinder 342 with cheese. This is accomplished by rotating the agitating arm 332 located inside the silo, and allowing the cheese to flow through the dispensing hole 328 at the base of the silo. Alternatively, the arm may simply be rotated several times without actually measuring or detecting that the measuring cylinder is full, with the assumption that a sufficient number or turns will adequately fill up the cylinder. In this alternative embodiment, a count or record must be kept to know approximately how much cheese remains in the silo. Otherwise, in the first embodiment, a sensor is mounted on the top of the cheese measuring cylinder to detect the presence of cheese at the top of the cylinder. In this case, when the sensor detects the presence of cheese near the top of the measuring cylinder, the agitating arm simply rotates enough to close the dispensing hole in the base of the silo. This method has the advantage of being able to detect if the measuring cylinder never gets filled up despite a sufficient number of turns of the agitating arm, which would indicate an empty silo condition. The measuring cylinder trap door 343 should be positioned such that it closes the bottom of the cylinder in order for the cylinder to fill up. A second sensor may also be used near the bottom of the measuring cylinder to detect that the cylinder has properly emptied, i.e., dispensed the cheese inside the cylinder.

The filling of the measuring cylinder preferably occurs prior to the pie crust being moved under either of the cheese dispensing mechanisms. After getting topped with sauce, the pie crust 260 is rotated to place the cheese chute 348 near the center of the pie.

Referring now to FIG. 11E, the measuring cylinder trap door 343 is rotated to a position that allows the cheese within the measuring cylinder to fall onto the pie. The measuring cylinder 342 may optionally be vibrated to facilitate the emptying of the cylinder. This may be accomplished either with a separate vibrating device mounted on the measuring cylinder (e.g., a hammer type mechanism), or by adding dimples on the trap door 343 such that, as the door is rotated, it collides with a bracket that touches the measuring cylinder, thus imparting some vibration to the measuring cylinder.

As the cheese falls onto the pie, some of it spreads out beyond the perimeter of the cheese chute 348, covering a large section of the center of the pie, but most of it remains backed up within the cheese chute 348. The turntable 302 then rotates to position the cheese chute closer to the perimeter of the pie crust 260. Simultaneously, the topping plate 304 begins to rotate. As the cheese chute 348 passes over sections of the pie without cheese on it, the cheese backed up in the chute empties out onto the pie, at a rate determined by the gap between the bottom of the chute and the surface of the pie, as well as the rotation speed and the shape of the rake pattern at the bottom end of the chute. The initial rotation of the topping plate is in a direction to push the cheese against the rake extensions at the bottom of the chute.

The cutout pattern at the bottom of the chute has three sections: a section with rake-like extensions that act to spread the cheese as it flows out, a solid section with no cutouts that is positioned near the perimeter of the pie and serves to limit the amount of cheese granules falling off of the pie, and an open section that comes into play at the very end of the cheese spreading cycle to allow any extra cheese remaining in the chute to fall out onto the pie.

After a timed cycle, the pie should be fully covered with cheese. However, due to potential variations in dough thickness, cheese quantity or the presence of clumps in the cheese, it is possible that not all of the cheese would have emptied from under the cheese chute. However, by having a relatively large opening in the cutout pattern at the bottom of the cheese chute, this permits the emptying of this extra cheese onto the pie by reversing the rotation of the topping plate for a short time after the pie has been completely covered.

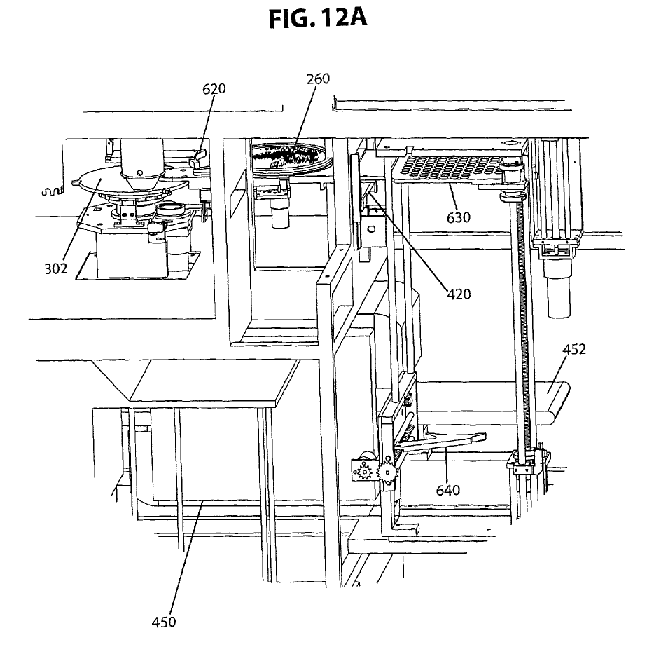

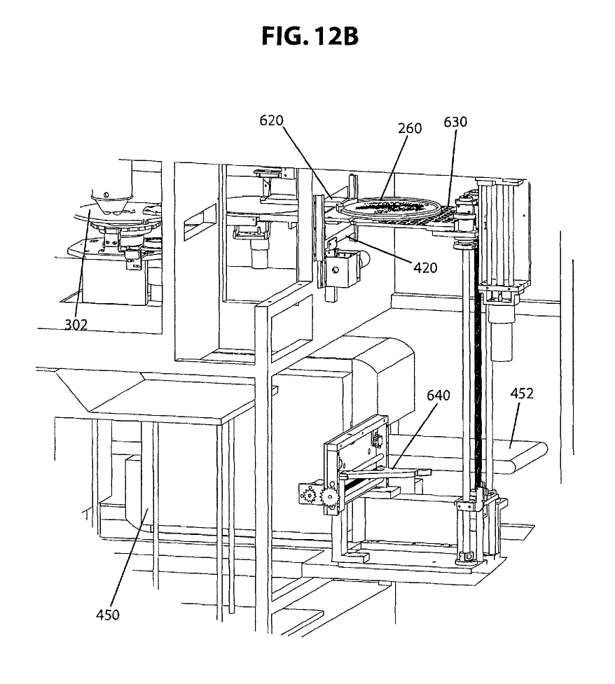

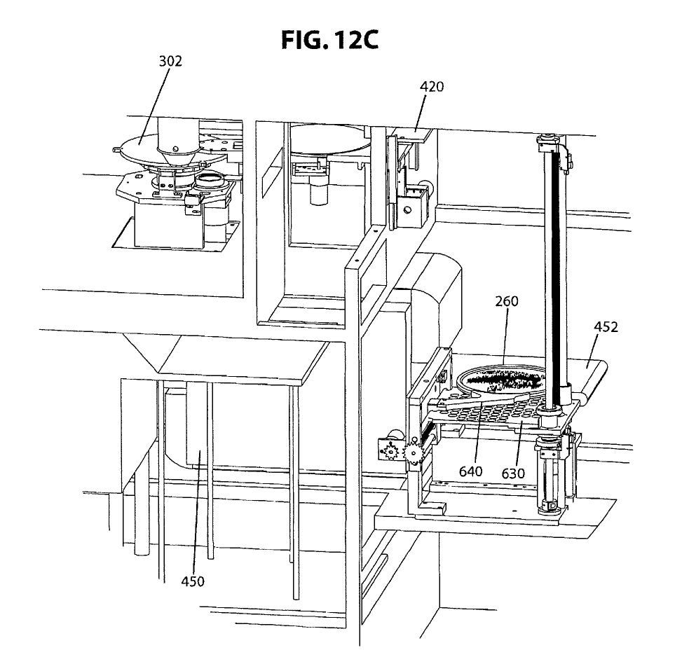

Referring now to FIGS. 12A-C, the pie transfer process to the oven will now be described. In these drawings, the press mechanism assembly has been removed to make the oven transfer mechanisms more visible. Once the pizza crust is covered with cheese, the turntable mechanism 302 rotates to position the pie topping plate 304 in-line with the elevator mechanism 630. Simultaneously, the topping area exit door 420 is opened. At this point the elevator transfer arm 620 pushes the fully topped pie crust onto the elevator 630, then retracts back to its original position. The turntable mechanism 302 is now free to rotate back to the original position to accept the next pie crust. The elevator then lowers the pizza crust to the level of the conveyor oven 450, and the oven transfer arm 640 pushes the pizza crust onto the oven conveyor belt 452. The oven transfer arm 640 then retracts back to its original position, as does the elevator 630.

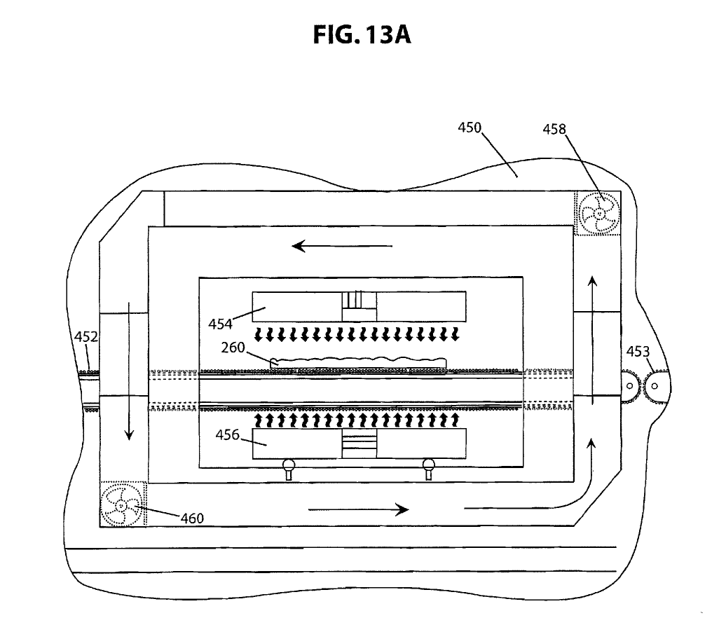

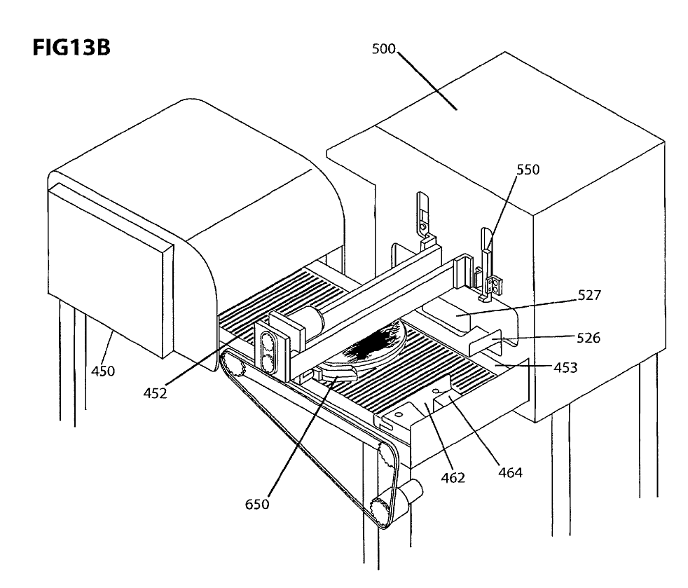

Referring now to FIG. 13A, the oven conveyor belt 452 turns on to transfer the pizza crust into the oven. The pizza is cooked within the oven using a pair of ceramic heating elements 454 and 456 located above and below the conveyor belt, respectively. The cooking time is approximately one minute. The cooking time may of course, be more or less, depending on many factors, such as crust thickness, oven temperature, etc. To minimize heat loss, instead of using doors, the oven generates air curtains at its entrance and exit openings to keep the hot air from escaping. These air curtains are generated with the use of two high temperature blowers 458 & 460 located at opposite corners of the oven. These blowers act to circulate a current of air around the perimeter of the oven, as indicated by the counter-clockwise arrows. Once the cooking is completed, the oven conveyor belt re-activates to transfer the pizza out of the oven.

Referring now to FIG. 13B, as the pizza exits the oven it passes from the oven conveyor belt 452 to a smaller exit conveyor belt 453. The pizza eventually collides with a deflector plate 462 that in turn triggers a limit switch 464 that signals for the conveyor belt to stop turning. Before describing the pie boxing process, the box preparation and forming process is now described.

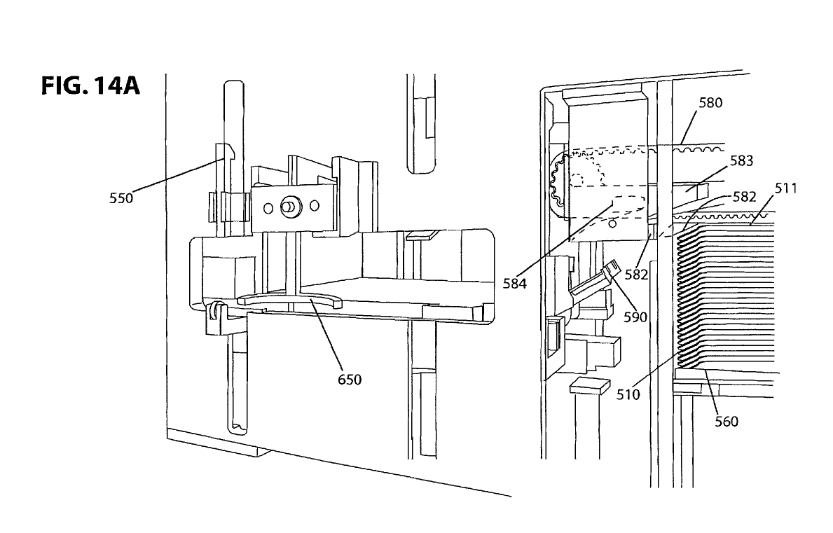

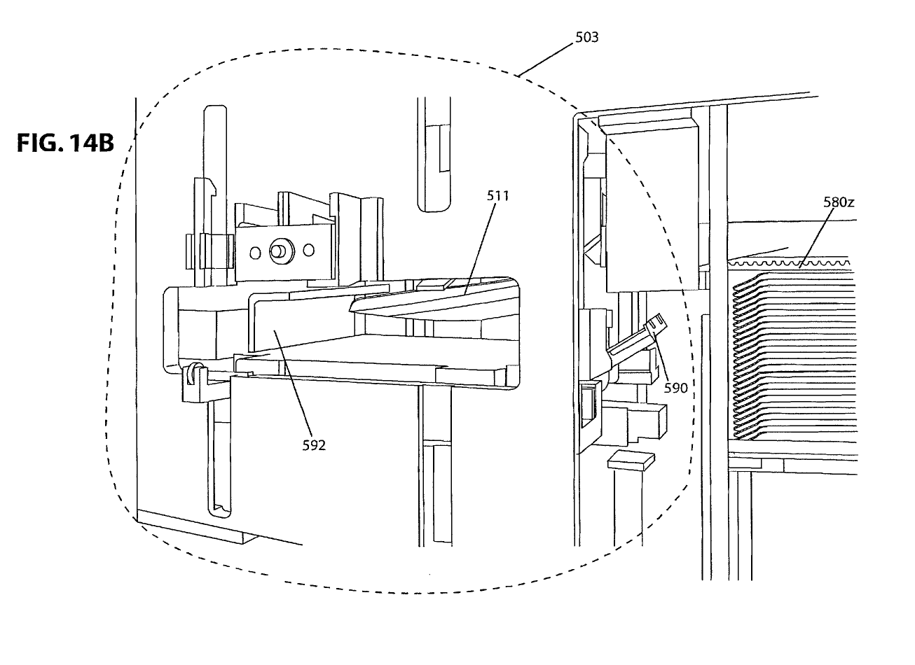

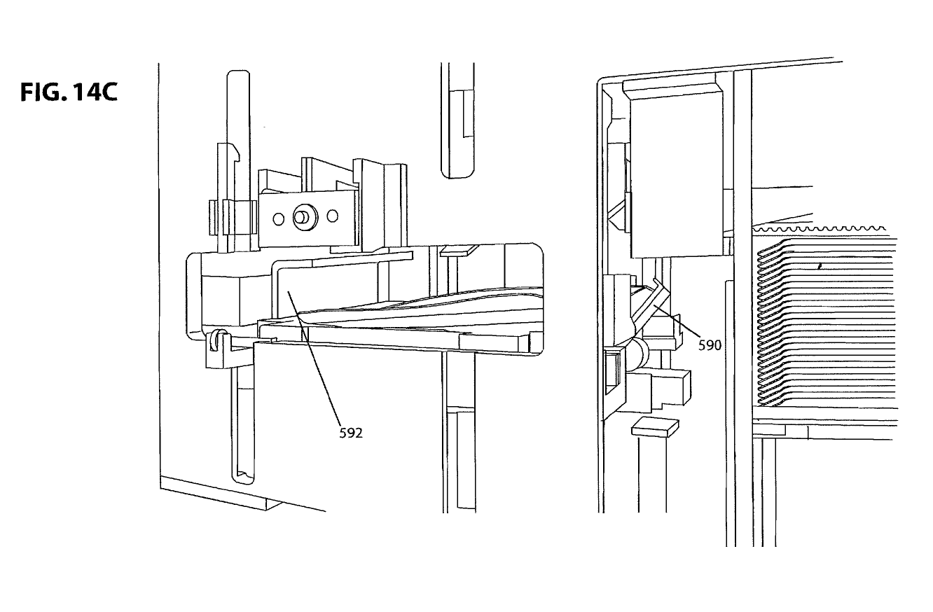

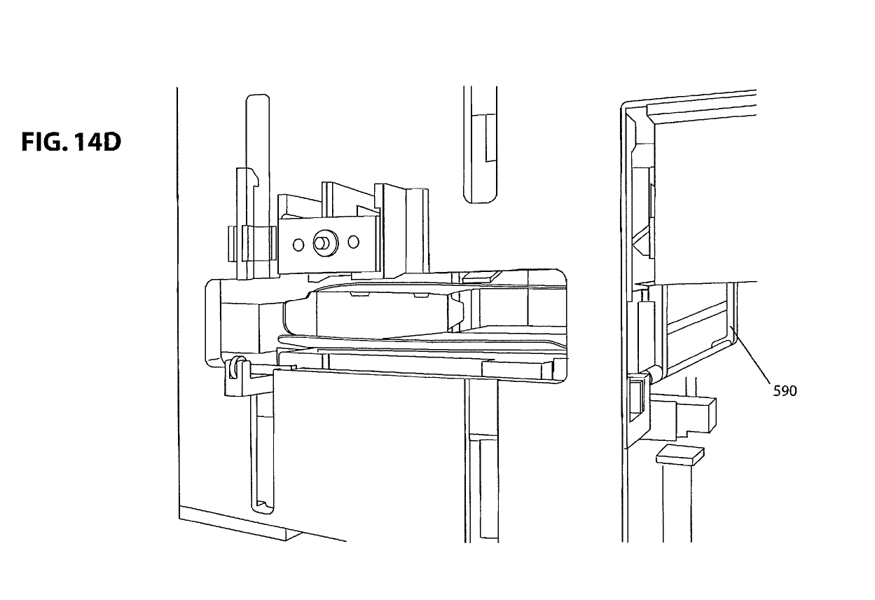

Referring now to FIG. 14A, therein is illustrated the pizza box forming system 500. The forming system includes two main areas: the box stack area 502 and the box flap closing area 503. The box stack area includes a stack elevator mechanism 560 that supports the stack of boxes 510 and the box separator belt 580 that transfers the topmost box 511 from the stack to the box flap closing area 503. The latter includes box bender mechanism 590, a pair of flap closing mechanisms, one in the front 530 and one in the rear 531. Finally, there is also a box transfer mechanism 650 that serves to push the pizza into an opened box, and then to push the closed box out of the machine.

Referring now to FIG. 14B, to separate a new box, the box separator belt 580 begins to spin as the box stack elevator mechanism 560 begins to rise. The topmost box 511 eventually comes into contact with the spinning separator belt 580. As enough pressure develops between the box stack and the belt, sufficient friction force is eventually generated for the belt to move the topmost box forward onto the box separation platform 582. A sensor or limit switch 584, shown with hidden lines and located above the separator platform detects the presence of the newly separated box and signals both the separator belt 580 and the box stack elevator 560 mechanism to stop moving. The stack elevator then reverses direction and begins to descend a short distance to relieve the pressure between the box stack and the separator belt. This ensures that a second box is not separated, because the previous box fully occupies the space available between the separator platform 582 and the belt 580, whereas there is no longer any friction between the belt and the next box on the stack.

Referring now to FIGS. 14C-D, the box separator belt 580 now recommences spinning and pushes the separated box down into flap closing area 503. Referring now to FIG. 14D, the newly separated box is bent open by the rotation of the box bending mechanism 590. The box is kept in position by the box bender pushing the box against the box support bracket 592, shown in FIG. 14D. The box is now in position, open and ready to accept the next pie.

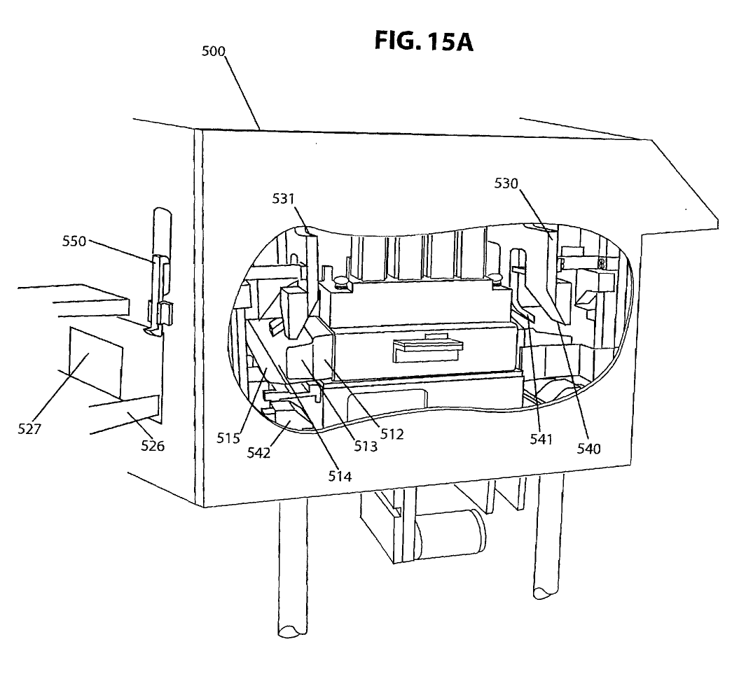

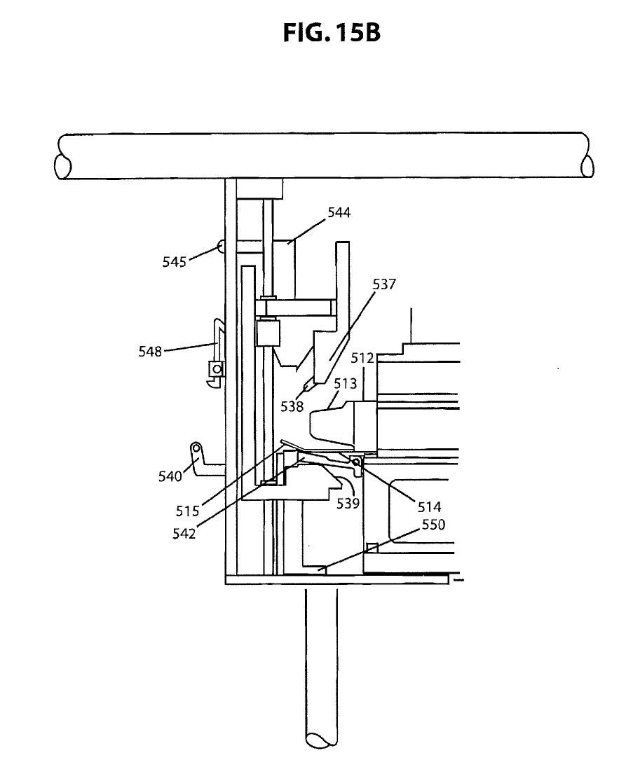

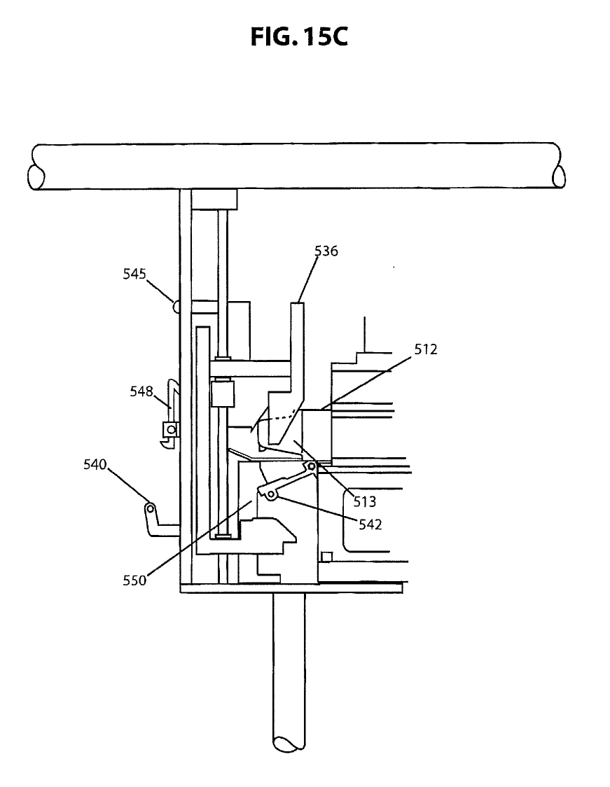

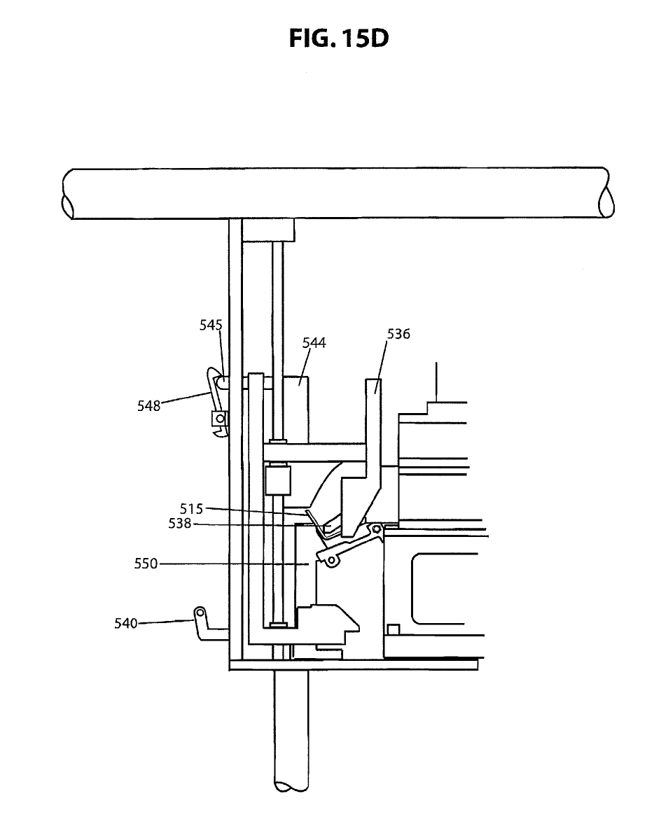

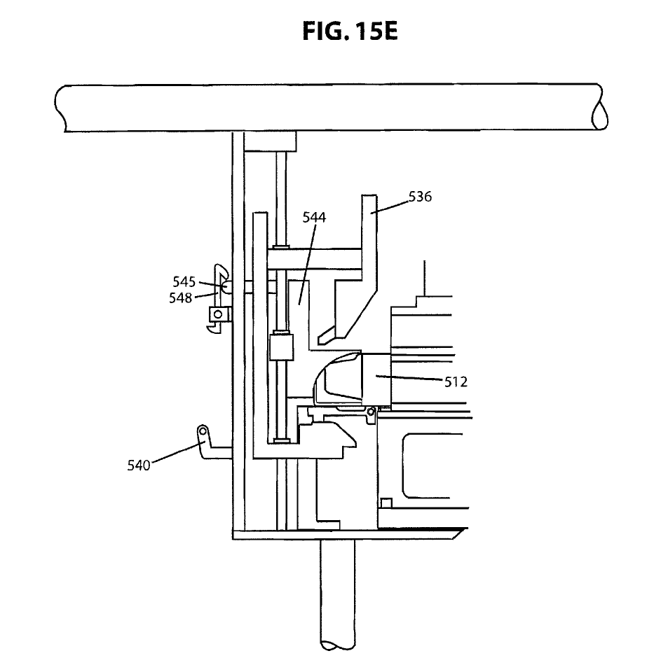

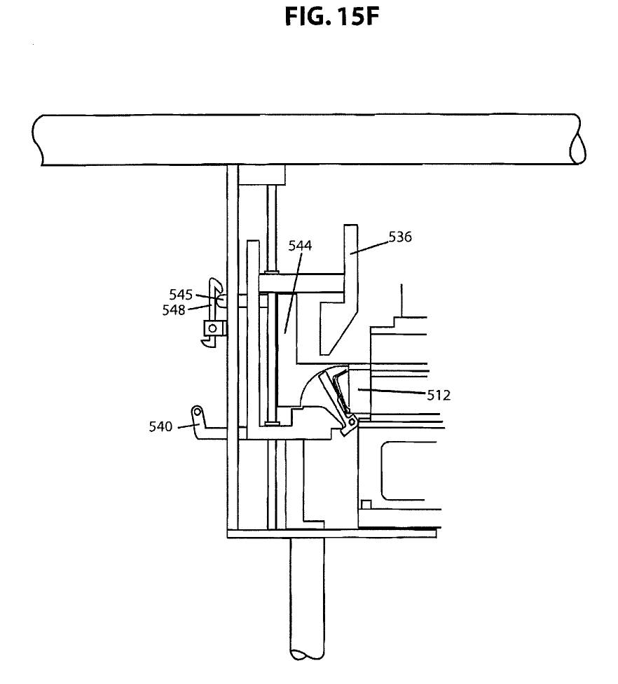

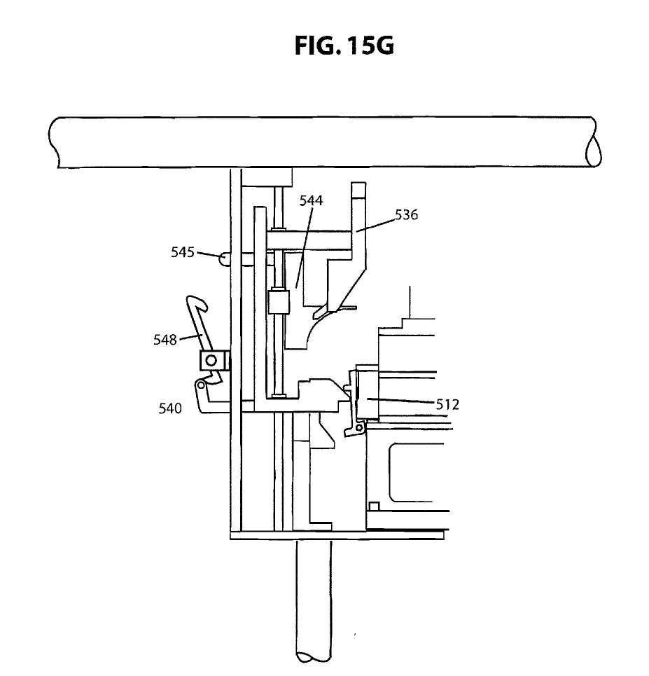

Now referring to FIG. 15A, therein is illustrated the rear flap closing mechanism 531, and the box transfer arm mechanism 650, as well as an opened pizza box 512, with the front and rear left side latching tongues 513 visible, along with the rear box closing flap 514, and the flap top latching tongue 515, which is the top part of the box closing flap 514.

Now, as the pie exits the oven and is centered with the box transfer arm 650, the latter moves forward to push the pizza into the previously opened box 512. As the pizza advances, it first moves over the bridge platform 526 and contacts a rotating box flap bridge 527 which pushes it down over the box flap 514, allowing the pie to slide freely into the box without interference from the box flap 514. In order not to interfere with the box flap closing process, the box transfer arm 650 then retracts back over the rotating flap bridge 527, out of the box flap closing area 503 and comes to a rest over the bridge platform 526.

At this point the front and rear flap closing mechanisms, 530 and 532, respectively, activate simultaneously to fold and then to close the front and rear box flaps 514. The operation of the rear flap folder 532 will now be described, it being understood that the front folder 530 operates in an essentially substantially similar fashion. The sub-components of the front and rear flap folding mechanisms have been numbered in a similar fashion. The following is a description of the flap closing process.

Referring now to FIG. 15B, the rear flap closing mechanism 532 is shown from a left side view. The mechanism includes a flap folding and pushing block 536 that moves down and then up, a flap closing guide 544 that is pushed down by the flap folding and pushing block and is pulled back up by a pull-up spring 546, a flap closing arm 542 and finally a stationary deflector 550 for the box flap top latching tongue. Although, the flap folding and pushing block 536 and the flap closing guide 544 are mounted on the same guide shaft 534, the actuating motor, not shown in the figure, is connected only to the flap folding and pushing block 536. As the latter moves down and then up the guide shaft 534, it comes into contact with the flap closing guide 544 and moves it as well. The flap folding and pushing block 536 is shaped to have three features or surfaces: the side tongue bending deflectors 537, the flap bending deflectors 538, and the flap closing arm deflectors 539. Due to the left hand side view of FIG. 15B, only one of each of these features, those on the left hand side are illustrated. They are repeated in a symmetrical fashion on the right hand side as well.

Referring now to FIGS. 15C and D, the flap closing cycle commences with the downward movement of the box flap folding and pushing block 536. As the latter descends, the side tongue bending deflectors 537 come into contact with the side latching tongues 513, and bend the latter inwards. Simultaneously, the flap bending deflectors 538 come into contact with the crease on the box closing flap 514, and bend the latter downward. As the flap 514 bends downward, the flap top latching tongue 515 comes into contact with the flap top deflector 550, and gets bent inward.

During this downward movement of the box flap folding and pushing block 536, as it is bending the box flap and tongues, it also pushes the flap closing guide mechanism 544 down to a position in front of the box opening, where the latter is held by a spring loaded latching hook 548 that holds onto latching extensions 545 on the flap closing guide.

Referring now to FIGS. 15E and F, the box flap folding and pushing block 536 now rises back to its original upper position, but the flap closing guide mechanism 544 remains in place due to the latching hook 548. At this point, the lower section of the flap folding and pushing block 536, the flap closing arm deflector 539, comes into contact with the flap closing arm mechanism 542, which rotates upwards to push the now bent box flap 514 up. As the upper flap tongue 515 slides against the flap closing guide mechanisms 544, it gets inserted into the box.

Referring now to FIG. 15G, as the flap folding and pushing block 536 approaches its uppermost position, the flap closing arm mechanism 542 rotates to a position beyond vertical, pushing the upper flap tongues all the way into the box, thus completing the box closing process. Finally, the box flap having been closed, the latching hook 548, which keeps the flap closing guide 544 in place, is released by the latching hook release cam 540 that is attached to the flap folding and pushing block 536, as the latter reaches its uppermost position. The triggering of the latching hook 548 allows the flap closing guide 544 to be pulled up from in front of the box by the springs 546.

Finally, the flap folding and pushing block 536 descends from its uppermost position back to its original position to clear the way for the box to be pushed out.

The box is then pushed out of both the flap closing area 503 and the machine by the forward movement of the box transfer arm 650, which advances all the way forward. The box transfer arm 650 then retracts all the way back to its original position. Finally, the pie bridge rotating flap 527 is pulled back up to the vertical position by a solenoid mechanism (not shown) to position it to be ready for the next pie. The flap closing mechanism is now ready to accept a newly separated box to be opened for the next pie.

The various mechanisms in the machine are driven by, for example, 24V DC motors, as well as mechanisms actuated by AC or DC solenoids. The machine also has a number of heater elements used as heat sources for the oven and hot press that cook the pie, as well as AC fans and hot air blowers. A central controller called the Vending Machine Controller (VMC) handles the customer interface tasks like validating the monetary transaction, printing out receipts, displaying messages, and communicating with the owner/operator's computer system for remote monitoring and control.

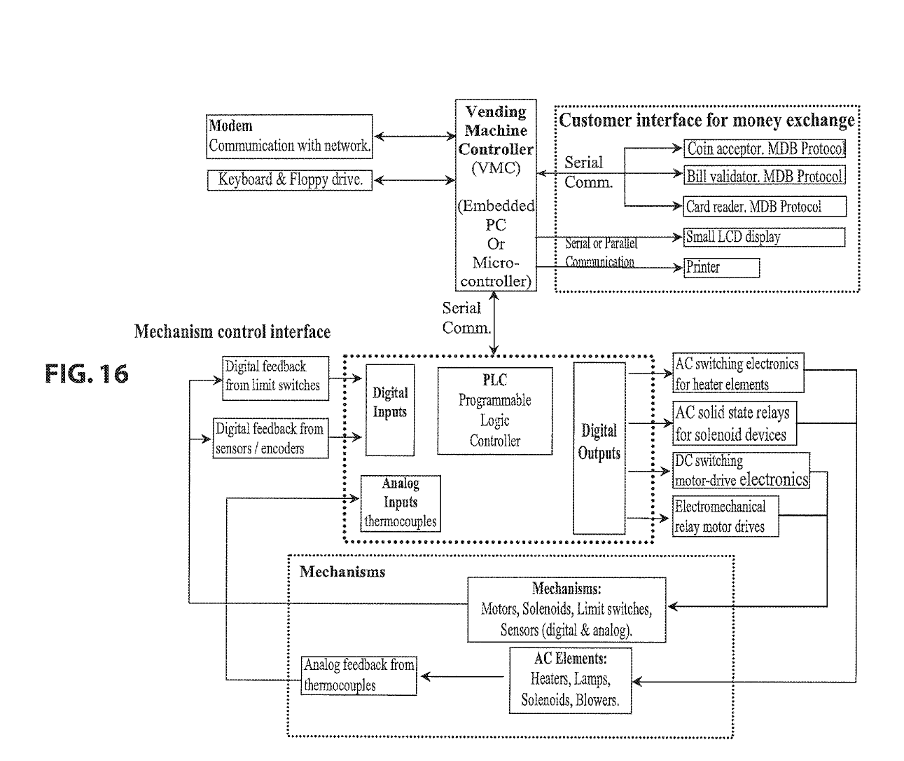

The actual control of the pizza making process and the mechanisms may be performed by a Programmable Logic Controller (PLC), a common type of controller in industrial applications. In this case, the VMC and the PLC may communicate via a serial port or some other type of communication connection. FIG. 16 is a block diagram showing the various functional elements of the control system.

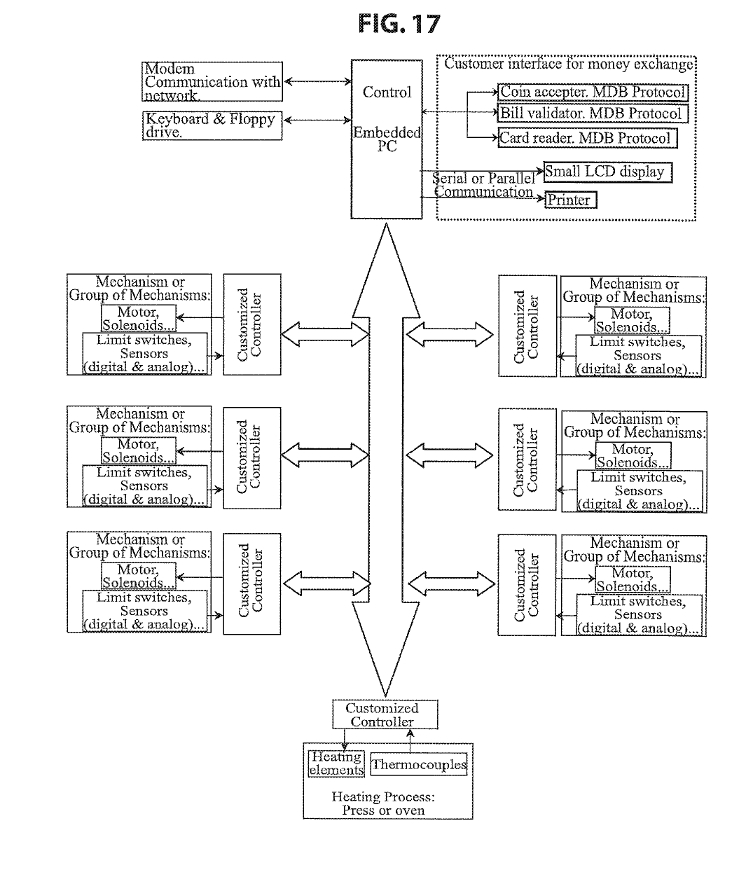

In an alternative configuration for the control system, the mechanism control tasks may be handled by customized controllers designed to handle either one mechanism or a group of related mechanisms, such as the canister handling and dough portioning system, the pressing system, the pie topping system. Whereas, the VMC manages the controllers for each sub-assembly or module, each individual controller would then be responsible to govern the movements of the mechanisms in that particular module. The advantage of this methodology over the PLC solution is first of all a reduction of wiring and associated costs, as this latter approach would only require two to four wires going from each controller to the VMC for power and communications. The controllers would in this case be located much closer to the sub-assembly to be controlled, thereby reducing potential noise pickup on the wires. Finally, customized controllers may be more economical to produce in volume. FIG. 17 is a block diagram of this alternative control system.

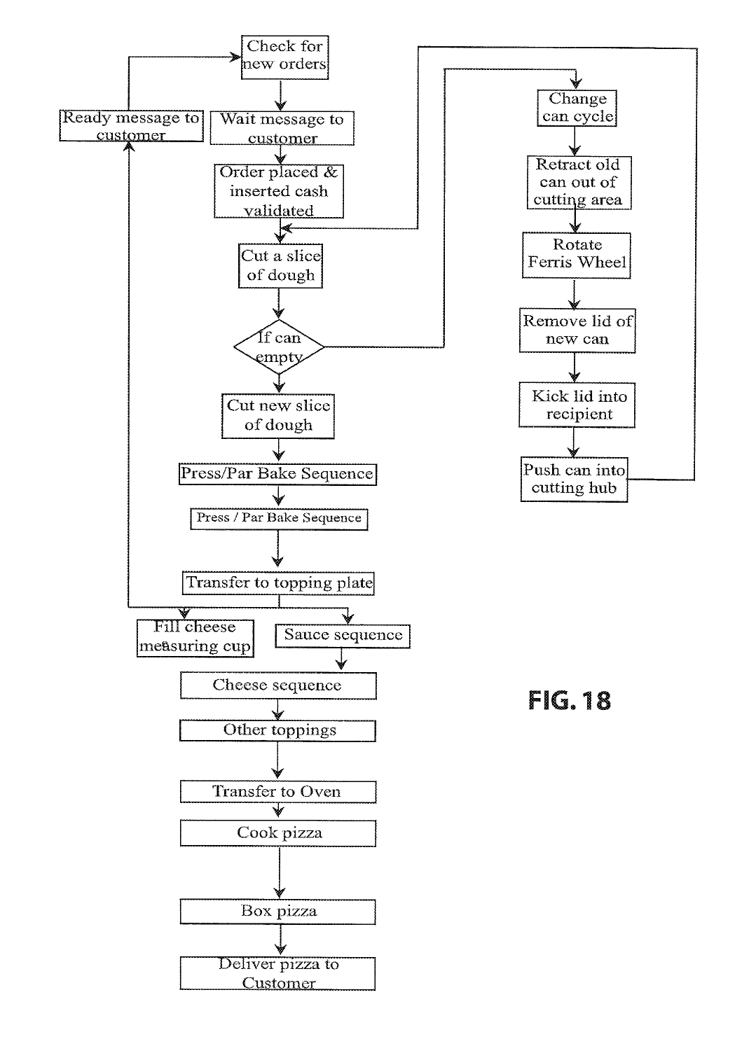

FIG. 18 is a flowchart illustrating the steps involved in the pizza ordering and preparation process. The VMC monitors the customer interface to see if an order is requested or if money has been deposited within the machine. If the Vending Machine is ready to make pies and when an order has been placed and the money accepted, the vending machine indicates to the PLC to commence a pie making cycle. The latter includes cutting a slice of dough, pressing and par-baking it, topping it, cooking it, and boxing it. A new order may be started as soon as the press area is free.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. An apparatus for making pizza, comprising:
a dough storage mechanism including a plurality of receptacles each for receiving a respective dough container;
a dough handling mechanism including an extruder operable to extract a predetermined portion of dough from one of said dough containers;
a dough cutting mechanism including at least one knife blade operable to cut said predetermined dough portion from one of said dough containers to create a cut dough portion;
a dough pressing mechanism operable to receive the cut dough portion and including at least one pressing plate operable to apply pressure to said cut dough portion to create a pizza crust;
a baking mechanism including at least one heated plate operable to apply heat to said pizza crust;
at least one topping storage and dispensing mechanism including at least one topping container and operable to dispense a predetermined portion of said at least one topping onto said pizza crust;
an oven including at least one heating element operable to receive said pizza crust containing said at least one topping and to provide heat for cooking said pizza crust containing said at least one topping; and
a packaging mechanism operable to receive a plurality of pizza packages, and including a folding mechanism operable to fold one of said pizza packages, such that said cooked pizza may be received into said folded package.

2. An apparatus for making a food product, comprising:
a dough storage mechanism including a plurality of receptacles arranged in a circular arrangement, each receptacle sized to receive a cylindrical dough container;
a dough handling mechanism including an extruder operable to extract a predetermined portion of dough from one of said dough containers, said extruder including at least one spring loaded hook operable to engage a peripheral rear portion of one of said dough containers, and a pusher assembly for pushing dough out of said dough container; and
a refrigerated housing section for receiving said dough storage mechanism and dough handling mechanism.

3. The apparatus of claim 2, wherein each said dough container initially includes a lid at a forward end of the container, the apparatus further including a lid removal clamp, the lid removal clamp including at least one moveable, spring loaded block having an opening adapted to receive the forward end of said dough container and sized so as to engage a lip portion of said dough container formed by the lid of the dough container, said extruder further being operable by way of said at least one hook to move said dough container in a direction away from said lid removal clamp such that said clamp assists in the removal of said lid from said dough container.

4. The apparatus of claim 3, further comprising a first photosensor positioned near said dough container and operable to provide a signal indicating that the dough portion being pushed out of said dough container has reached a predetermined dough portion.

5. The apparatus of claim 4, further comprising a dough cutting mechanism including at least knife blade operable to cut the predetermined portion of dough from said dough container, said knife blade being activated in response to the signal from the first photosensor.

6. An apparatus for making a food product, comprising:
a dough pressing mechanism operable to receive a predetermined sized dough portion and including at least one pressing plate operable to apply pressure to said dough portion to create a pizza crust, said dough pressing mechanism including:
a top press plate;
a lower press plate positioned below the top press plate;
a pusher plate positioned above said top press plate, said pusher plate being controllably actuated to move in an axial direction relative to said top press plate;
at least one spring loaded shoulder screw provided between and engaging both said top press plate and said pusher plate to allow controlled positioning of the top press plate with respect to the pusher plate;
at least one of said top press plate and said lower press plate including a cavity for receiving said dough portion;
wherein said pusher plate is selectively actuated to:
(a) move said top press plate toward and into engagement with said lower press plate so as to apply pressure to said dough portion;
(b) move said top press plate away from said lower press plate so as to allow release of pressure from within the cavity receiving the dough portion;
such that subsequent to the release of said pressure, said shoulder screw allows said top press plate to move toward said lower press plate up to a predetermined top press plate position in order to create a predetermined size for said cavity formed by one or more of the top press plate and the lower press plate.

7. The apparatus of claim 6, wherein at least one of the top press plate and the lower press plate is provided with a heating mechanism.

8. An apparatus for making a food product, comprising:
at least one topping storage and dispensing mechanism including at least one topping container and operable to dispense a predetermined portion of said at least one topping onto a pizza crust, wherein the at least one topping includes sauce and the at least one topping container includes a sauce container and the dispensing mechanism includes a pump for selectively dispensing the sauce from the sauce container onto the pizza crust;
a rotating mechanism for supporting the pizza crust and rotating the pizza crust relative to the sauce container such that sauce is dispensed from the sauce container as the pizza crust is rotated relative to the sauce container;

9. The apparatus of claim 8, wherein the sauce is dispensed in a generally circular pattern onto the pizza crust and the rotating mechanism further includes an indexing apparatus for indexing the pizza crust in a direction generally orthogonal to a direction of the sauce being dispensed such that sauce can then be dispensed in a generally circular pattern onto an area of the pizza which has not yet been dispensed with sauce.

10. The apparatus of claim 8, wherein the at least one topping includes cheese and the at least one topping container includes a cheese container and the dispensing mechanism includes a measuring container for selectively dispensing a predetermined amount of cheese from the cheese container onto the pizza crust, and wherein the measuring container is positioned in connection with and below the cheese container for receiving cheese from the cheese container through a selectively operable opening in a bottom of the cheese container.

11. The apparatus of claim 10, further comprising a second photosensor positioned in proximity to the measuring container for providing a signal indicating when the predetermined amount of cheese has been provided from the cheese container into the measuring container, the measuring container including a selectively openable opening in a bottom region of the measuring container for dispensing the predetermined amount of cheese from the measuring container onto the pizza crust in accordance with the signal from the second photosensor.

12. The apparatus of claim 11, wherein the rotating mechanism is operable to rotate the pizza crust relative to the measuring container such that cheese is dispensed from the measuring container as the pizza crust is rotated relative to the measuring container.

13. The apparatus of claim 12, further comprising a vibrating mechanism for applying vibrations to the measuring container as cheese is being dispensed.

14. The apparatus of claim 13, wherein the vibrating mechanism includes a hammer adapted to engage the measuring container, or a plurality of bumps positioned on the measuring container which are engaged during rotation of the pizza crust.

15. The apparatus of claim 11, further including a third photosensor positioned in proximity to a bottom portion of the measuring container for providing a signal indicating that the cheese in the measuring container has been dispensed.

16. The apparatus of claim 10, further including a refrigerated section for housing said topping containers.

17. An apparatus for making a food product, comprising:
a conveyer belt for receiving a pizza crust;
an oven positioned in proximity to said conveyer belt and including at least one heating element operable to provide heat for cooking said pizza crust, said oven further including at least two high temperature blowers provided at opposite corners of said oven to create an air curtain which acts to generally maintain heated air within the oven by circulating air currents around a perimeter of the oven.

18. The apparatus of claim 17 wherein said oven includes a first heating element above said conveyer belt and a second heating element below said conveyer belt.

19. The apparatus of claim 1, wherein the pizza packages are initially in the form of flat boxes which are in a stacked arrangement, and the packaging mechanism includes a box separator belt operable to frictionally engage and separate a selected pizza package from the stack of flat boxes, and an elevator mechanism operable to lower the stack of flat boxes once the separator belt has engaged and separated the selected box from the stack of flat boxes.

20. The apparatus of claim 19, wherein the packaging mechanism includes a box bending mechanism for bending said selected flat box into a generally three-dimensional box having a front flap and a rear flap, and wherein said folding mechanism includes a rear flap folding mechanism and a front flap folding mechanism.

21. The apparatus of claim 1, wherein the apparatus is provided in the form of a vending machine.

22. The apparatus of claim 2, wherein the apparatus is provided in the form of a vending machine.

23. The apparatus of claim 6, wherein the apparatus is provided in the form of a vending machine.

24. The apparatus of claim 8, wherein the apparatus is provided in the form of a vending machine.

25. The apparatus of claim 17, wherein the apparatus is provided in the form of a vending machine.

26. A method of making pizza using a vending machine apparatus, the method comprising the following steps:
extracting a predetermined portion of dough from a dough container provided in a receptacle of a dough storage mechanism;
using a dough cutting mechanism including at least one knife blade to cut said predetermined dough portion from one of said dough containers to create a cut dough portion;
using a dough pressing mechanism to receive the cut dough portion and including at least one pressing plate to apply pressure to said cut dough portion to create a pizza crust;
baking said cut dough portion using a baking mechanism including at least one heated plate to apply heat to said pizza crust;
using at least one topping storage and dispensing mechanism including at least one topping container to dispense a predetermined portion of said at least one topping onto said pizza crust;
using an oven including at least one heating element operable to receive said pizza crust containing said at least one topping to provide heat for cooking said pizza crust containing said at least one topping; and
using a packaging mechanism operable to receive a plurality of pizza packages, and including a folding mechanism operable to fold one of said pizza packages, such that said cooked pizza may be received into said folded package.

27. A computer software product comprising a tangible computer-readable medium in which program instructions are stored, which instructions, when read by a computer, cause the computer to execute the following steps in controlling an apparatus for making pizza:
extracting a predetermined portion of dough from a dough container provided in a receptacle of a dough storage mechanism;
using a dough cutting mechanism including at least one knife blade to cut said predetermined dough portion from one of said dough containers to create a cut dough portion;
using a dough pressing mechanism to receive the cut dough portion and including at least one pressing plate to apply pressure to said cut dough portion to create a pizza crust;
baking said cut dough portion using a baking mechanism including at least one heated plate to apply heat to said pizza crust;
using at least one topping storage and dispensing mechanism including at least one topping container to dispense a predetermined portion of said at least one topping onto said pizza crust;
using an oven including at least one heating element operable to receive said pizza crust containing said at least one topping to provide heat for cooking said pizza crust containing said at least one topping; and
using a packaging mechanism operable to receive a plurality of pizza packages, and including a folding mechanism operable to fold one of said pizza packages, such that said cooked pizza may be received into said folded package.

28. A programmed processor for controlling an apparatus for making pizza, comprising:
a programmed microprocessor;
a program memory device containing instructions for causing the programmed microprocessor to perform the following steps in controlling an apparatus for making pizza:
extracting a predetermined portion of dough from a dough container provided in a receptacle of a dough storage mechanism;
using a dough cutting mechanism including at least one knife blade to cut said predetermined dough portion from one of said dough containers to create a cut dough portion;
using a dough pressing mechanism to receive the cut dough portion and including at least one pressing plate to apply pressure to said cut dough portion to create a pizza crust;
baking said cut dough portion using a baking mechanism including at least one heated plate to apply heat to said pizza crust;
using at least one topping storage and dispensing mechanism including at least one topping container to dispense a predetermined portion of said at least one topping onto said pizza crust;
using an oven including at least one heating element operable to receive said pizza crust containing said at least one topping to provide heat for cooking said pizza crust containing said at least one topping; and
using a packaging mechanism operable to receive a plurality of pizza packages, and including a folding mechanism operable to fold one of said pizza packages, such that said cooked pizza may be received into said folded package.
